(19) United States
(12) Patent Application Publication
(10) Pub. No.: US 2018/0232693 A1
(43) Pub. Date: Aug. 16, 2018

(54) Autonomous services selection system and distributed transportation database(s)

(71) Applicant: United Parcel Service of America, Inc., Atlanta, GA (US)

(72) Inventors: Robert J. Gillen, Johns Creek, GA (US); Arkadiusz Komenda, Mahwah, NJ (US); Konstantin Tadenev, Mahwah, NJ (US)

(21) Appl. No.: 15/932,328

(22) Filed: Feb. 16, 2018

Related U.S. Application Data
(60) Provisional application No. 62/459,807, filed on Feb. 16, 2017.

(51) Int. Cl. G06Q 10/08; G06F 17/30

(52) U.S. Cl. CPC G06Q 10/0834; G06F 17/30604; G06F 17/30283; G06Q 10/0833

(57) ABSTRACT

Systems and methods are provided for the automated determination and facilitation of a transportation plan for transporting a shipment unit containing at least one shipment unit through one or more transportation networks corresponding to one or more carriers. An exemplary method comprises receiving and storing in a distributed ledger service offers for transporting a shipment unit; receiving and storing in a distributed ledger shipment unit data comprising an origin, a destination, and transportation parameters; matching service offers stored in the distributed ledger to the shipment unit data to generate a transportation plan for transporting the shipment unit in accordance with the shipment unit data, each service offer corresponding to a leg of the transportation plan, receiving and storing in the distributed ledger an indication of completion of a particular leg of the transportation plan, and causing payment of an entity for transporting the shipment unit along the particular leg.

### CROSS REFERENCE TO RELATED APPLICATIONS

This application claims priority to Provisional Patent Application No. 62/459,807, filed Feb. 16, 2017, and entitled “AUTONOMOUS SERVICES SELECTION SYSTEM,” the entire contents of which is incorporated herein by reference in its entirety.

### BACKGROUND

Generally, when a shipment unit is received by a logistics service provider for transporting from an origin to a destination, the logistics service provider determines a routing of the shipment unit through the logistics service provider's transportation network. However, the shipment unit may need to travel through and/or to a region of the world not serviced by the logistics service provider. For example, a shipment unit may be mailed through the U.S. Postal Service to a delivery address in China. Therefore, there may be scenarios in which it is advantageous for various logistics service providers to transport the shipment unit along different legs/segments from its origin to its destination. However, it may be difficult to coordinate the transportation of the shipment unit through the various logistics service provider transportation networks. Moreover, if there are special handling requirements for transporting the shipment unit, it may be difficult to ensure that the special handling requirements are carried through by each of the various logistics service providers that may assist in transporting the shipment unit.

Additionally, shipping consumers are constantly looking for new shipping services providing enhanced shipment unit shipping/tracking visibility while minimizing costs. As new shipment unit transportation methodologies such as crowd-sourced shipment unit delivery networks become more commonplace, a need exists for verifiable shipment unit shipping and tracking visibility systems providing shipment unit location visibility for shipment units transported and/or exchanged within a single carrier, as well as for shipment units transported and/or exchanged between multiple carriers as the shipment unit is transported from a shipment origin to a shipment destination.

### BRIEF SUMMARY

Example embodiments provide methods, systems, apparatuses, computer program products for autonomously matching a shipment unit to one or more service offers provided by one or more logistics service providers (e.g., carriers) for transporting the shipment unit for at least a leg/segment from an origin location to a destination location based on the shipment unit information/data. As will be referenced herein, a shipment unit can be interpreted as any material, item, object, or container that is capable of being transported from one location to another. By way of non-limiting example, a shipment unit can include one or more items, objects, packages, containers, trailers, rail cars, vehicles, pallets, and/or pallets carrying a variety of shipment units, among other things. In some aspects, any of the foregoing shipment units can contain additional shipment units, or in the alternative, can be empty. It is further contemplated that any of the foregoing shipment units can employ any portion and/or combination of conventional shipment unit tracking systems and/or methodologies as it moves throughout one or more carrier networks, as one of ordinary skill in the art may appreciate.

In various embodiments, transportation information/data may be provided by the shipment unit itself as it is transported from the origin location to the destination location. The transportation information/data may be stored in a transportation database that comprises one or more distributed ledgers and/or blockchain structures, in an example embodiment. Thus, in an example embodiment, an immutable ledger of the environmental conditions experienced by the shipment unit as it is transported may be stored. In an example embodiment, the transportation database may be used to determine one or more automated, unbiased logistics service provider/carriers/transporter reviews.

According to a first aspect, a method for monitoring and/or facilitating the transportation of a first shipment unit containing at least one other shipment unit from an origin to a destination is provided. In an example embodiment, the method comprises receiving and storing in a service offer distributed ledger, by a computing node entity comprising at least one processor, a memory, and a communications interface configured to communicate via at least one network, one or more service offers for transporting a shipment unit through at least a portion of a transportation network; receiving and storing in a transportation distributed ledger, by the computing node entity, shipment unit data corresponding to the first shipment unit and comprising (a) an origin, (b) a destination, and (c) one or more transportation parameters corresponding to transporting the first shipment unit from the origin to the destination; matching at least one of the one or more service offers stored in the service offer distributed ledger to the shipment unit data to generate a transportation plan for transporting the first shipment unit from the origin to the destination in accordance with the one or more transportation parameters, each service offer of the one or more service offers corresponding to transporting the first shipment unit along a leg of the transportation plan; receiving and storing in the transportation distributed ledger, by the computing node entity, an indication of completion of a particular leg of the transportation plan; and based on the shipment unit data and a service offer of the one or more service offers and corresponding to the particular leg, causing payment, by the computing node entity, of an entity for transporting the shipment unit along the particular leg.

According to another aspect, an apparatus for monitoring and/or facilitating the transportation of a first shipment unit containing at least one other shipment unit from an origin to a destination is provided. In an example embodiment, the apparatus comprises at least one processor, a communications interface configured for communicating via at least one network, and at least one memory storing computer program code. The at least one memory and the computer program code are configured to, with the processor, cause the apparatus to at least receive and store in a service offer distributed ledger one or more service offers for transporting a shipment unit through at least a portion of a transportation network; receive and store in a transportation distributed ledger shipment unit data corresponding to the first shipment unit and comprising (a) an origin, (b) a destination, and (c) one or more transportation parameters corresponding to transporting the first shipment unit from the origin to the destination; match at least one of the one or more service offers stored in the service offer distributed ledger to the shipment unit data to generate a transportation plan for transporting the first shipment unit from the origin to the destination in accordance with the one or more transportation parameters, each service offer of the one or more service offers corresponding to transporting the first shipment unit along a leg of the transportation plan; receive and store in the transportation distributed ledger an indication of completion of a particular leg of the transportation plan; and based on the shipment unit data and a service offer of the one or more service offers and corresponding to the particular leg, causing payment of an entity for transporting the first shipment unit along the particular leg.

According to yet another aspect, a computer program product for monitoring and/or facilitating the transportation of a first shipment unit containing at least one other shipment unit from an origin to a destination is provided. In an example embodiment, the computer program product comprises at least one non-transitory computer-readable storage medium having computer-executable program code instructions stored therein. The computer-executable program code instructions comprise program code instructions configured to, when executed by a processor of a node computing entity cause the node computing entity to receive and store in a service offer distributed ledger one or more service offers for transporting a shipment unit through at least a portion of a transportation network; receive and store in a transportation distributed ledger shipment unit data corresponding to the first shipment unit and comprising (a) an origin, (b) a destination, and (c) one or more transportation parameters corresponding to transporting the first shipment unit from the origin to the destination; match at least one of the one or more service offers stored in the service offer distributed ledger to the shipment unit data to generate a transportation plan for transporting the first shipment unit from the origin to the destination in accordance with the one or more transportation parameters, each service offer of the one or more service offers corresponding to transporting the first shipment unit along a leg of the transportation plan; receive and store in the transportation distributed ledger an indication of completion of a particular leg of the transportation plan; and based on the shipment unit data and a service offer of the one or more service offers and corresponding to the particular leg, causing payment of an entity for transporting the first shipment unit along the particular leg.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a computing node entity according to one embodiment of the present invention.

FIG. 3 is an exemplary schematic diagram of a transaction computing entity according to one embodiment of the present invention.

FIG. 4 provides a flowchart illustrating example processes and procedures for providing transportation services in accordance with an example embodiment of the present invention.

FIG. 5 is an exemplary user interface for providing a service offer according to one embodiment of the present invention.

FIG. 5A is an exemplary data construct of service offer information/data according to one embodiment of the present invention.

FIG. 6 is an exemplary user interface for providing shipment unit information/data in accordance with an example embodiment of the present invention.

FIG. 6A is an exemplary data construct of bid information/data comprising shipment unit information/data according to one embodiment of the present information/data according to one embodiment of the present invention.

FIG. 6B is an exemplary data construct of shipment information/data comprising shipment unit information/data that has been updated based on the selected service offer(s) and/or the completed transportation of the shipment unit according to one embodiment of the present invention.

FIG. 7 provides an example high level information/data flow according to an example embodiment of the present invention.

### DETAILED DESCRIPTION OF EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. General Overview

Example embodiments of the present invention provide for autonomous selection of shipping options based on stored service offers and shipment unit information/data for a shipment unit. In accordance with embodiments described herein, a shipment unit can be generally referenced as any material, item, object, or container that is capable of being transported from one location to another. As was briefly described herein, a shipment unit can enclose, be enclosed by, be bundled with, or grouped together with, another “associated” shipment unit. In this regard, any shipment unit that is referenced herein can be a shipment unit that is “associated” with another shipment unit can be, among other things, an enclosing shipment unit (one that contains at least one other), an enclosed shipment unit (one that is contained in at least one other), a bundled shipping unit (one that is bundled with at least one other), or a grouped shipping unit (one that is grouped with at least one other).

In various aspects of the present disclosure, one or more logistics service providers, transporters, carriers, and/or the like (referred to generally as “carriers” herein) may provide one or more service offers for transporting shipment units. The service offers may be stored in a service offer database. In an example embodiment, the service offer database comprises one or more blockchain data structures and/or other distributed databases and/or ledgers.

A shipment unit may enter the transportation network of a logistics service provider/carrier/transporter affiliated with a service offer database. Shipment unit information/data comprising information/data related to the transportation of the shipment unit (e.g., origin, destination, payment information/data, special handling instructions, and/or the like) may be provided by the shipment unit, by a transaction computing entity 110, and/or the like. The shipment unit information/data may be accessed in response to detecting the presence of the shipment unit within the logistics service provider/carrier/transporter's transportation network (e.g., when a logistics service provider/carrier/transporter personal picks up the shipment unit from the consignor, the shipment unit is scanned and/or detected within a facility of the logistics service provider/carrier/transporter, and/or the like).

The shipment unit information/data may be used to match the shipment unit to one or more service offers stored in the service offer database. The shipment unit and/or a computing entity may then select one or more service offers from the service offer database for the transportation of the shipment unit from the origin to the destination based on a rating identified with each logistics service provider/carrier/transporter and matching the one or more service offers to the requirements and preferences for transporting the shipment unit as detailed by the shipment unit information/data. A selected service offer database may store information/data identifying the selected service offers for transporting the shipment unit form the origin to the destination. In an example embodiment, the selected service offer database may comprise one or more blockchain data structures.

The shipment unit and/or other computing entities may provide transportation information/data as the shipment unit is transported from the origin to the destination in accordance with selected service offer(s) such that the location and/or conditions experienced by the shipment unit may be documented. For example, the transportation information/data may be stored in a transportation database. The transportation database may comprise one or more blockchain data structures, according to an example embodiment. Upon the completion of the shipment unit being transported from the origin to the destination (and/or upon the completion of each leg thereof) the logistics service provider/carrier/transporter may be automatically rated based on the completion of transporting the shipment unit in accordance with the selected service offer. The rating may be stored in the service offer database, and/or the like. In an example embodiment, payment for services rendered for transporting the shipment unit from the origin to the destination and/or along a leg thereof may be facilitated after the completion of the transporting the shipment unit from the origin to the destination and/or along a leg thereof.

Various embodiments provide systems and methods for providing shipment unit and/or associated shipment unit shipping/visibility information via a transportation database. In various embodiments, the transportation database may be one or more distributed ledger (e.g., blockchain) databases. The transportation database system may be a public or private database, and may be stored on a plurality of computing nodes to provide backup storage and/or to provide transaction verification mechanisms as discussed herein.

In certain embodiments, the transportation database system may comprise data indicative of a plurality of transactions/blocks, wherein later-in-time generated transactions/blocks are electronically linked to prior-generated transactions/blocks to provide a completely linked block chain indicative of each transaction for which information/data is stored in the distributed ledger. Moreover, each block may comprise information/data identifying a particular shipment unit and/or associated shipment unit (e.g., shipment unit level detail providing a plurality of information/data points relating to a particular shipment unit), and may comprise a control identifier indicative of an entity, individual, and/or location having control over the shipment unit and/or associated shipment unit. Accordingly, by identifying all transactions/blocks stored in the distributed ledger relating to a particular shipment unit and/or associated shipment unit, a complete chain-of-control may be identified for a particular shipment unit and/or associated shipment unit.

In various embodiments, each new block of an example transportation database may be generated upon receipt of information/data indicating a change in control of a stored shipment unit and/or associated shipment unit (e.g., received by a computer node). For example, each time control of a shipment unit and/or associated shipment unit moves from a first carrier personnel (e.g., a sort personnel) to a second carrier personnel (e.g., a delivery driver/delivery vehicle), a new block may be generated for the distributed ledger. In certain embodiments, a plurality of transaction computing entities may be configured to monitor and/or update control information/data for a plurality of shipment units and/or associated shipment units, based on wireless communication between a plurality of transaction computing entities, the shipment unit and/or associated shipment unit, and/or the like. For example, each time a shipment unit is scanned (e.g., via a barcode scanner), a new block may be generated in the distributed ledger to reflect the newly identified location of the shipment unit.

Certain embodiments may comprise a plurality of linked distributed ledgers (e.g., a first distributed ledger relating to a first set of shipment units and a second distributed ledger relating to a second set of shipment units associated with the first set of shipment units), each providing varying information/data regarding respective asset types (e.g., shipment units and/or associated shipment units). Thus, certain embodiments enable tracking of a first set of shipment units and a second set of shipment units associated with the first set of shipment units separately, thereby enabling the use of various smart contracts relating to shipping services and shipment unit handling in a bifurcated manner.

The smart contracts may be automatically enforceable to transfer value between various parties involved in shipping transactions based on the occurrence of various trigger events. Those trigger events, such as the pick-up/transfer/delivery of a shipment unit, the occurrence of an undesirable environmental condition, and/or the like, may be identified in information/data stored in one or more transactions/blocks relating to a particular shipment unit and/or associated shipment unit. Thus, based on information/data added to the distributed ledger (e.g., as one or more transactions/blocks), the distributed ledger system may be configured to automatically transfer value between a plurality of parties. For example, upon successful pick-up/transfer/delivery of a shipment unit, value (e.g., in the form of digital currency) may be transferred from a shipment unit consignor to a carrier. Upon a determination that a particular shipment unit's temperature was allowed to exceed a predefined threshold, value may be transferred from the carrier to a consignor.

The amount of value to be transferred may be assigned based on the shipment unit for which a smart contract is related. For example, the maximum amount of value that may be transferred relating to a particular shipment unit may be limited to the value of shipping services provided, and the maximum amount of value that may be transferred relating to a particular shipment unit may be limited to the value of the shipment unit itself Thus, if a shipment unit is not delivered in accordance with agreed upon parameters, the consignor may receive a refund of at least a portion of the value of the shipping services (or may pay the carrier less than the agreed-upon shipping services value); and if a shipment unit is damaged/destroyed during shipping, the carrier may pay the consignor at least a portion of the value of the damaged/destroyed shipment unit.

### II. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magneto resistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Exemplary System Architecture

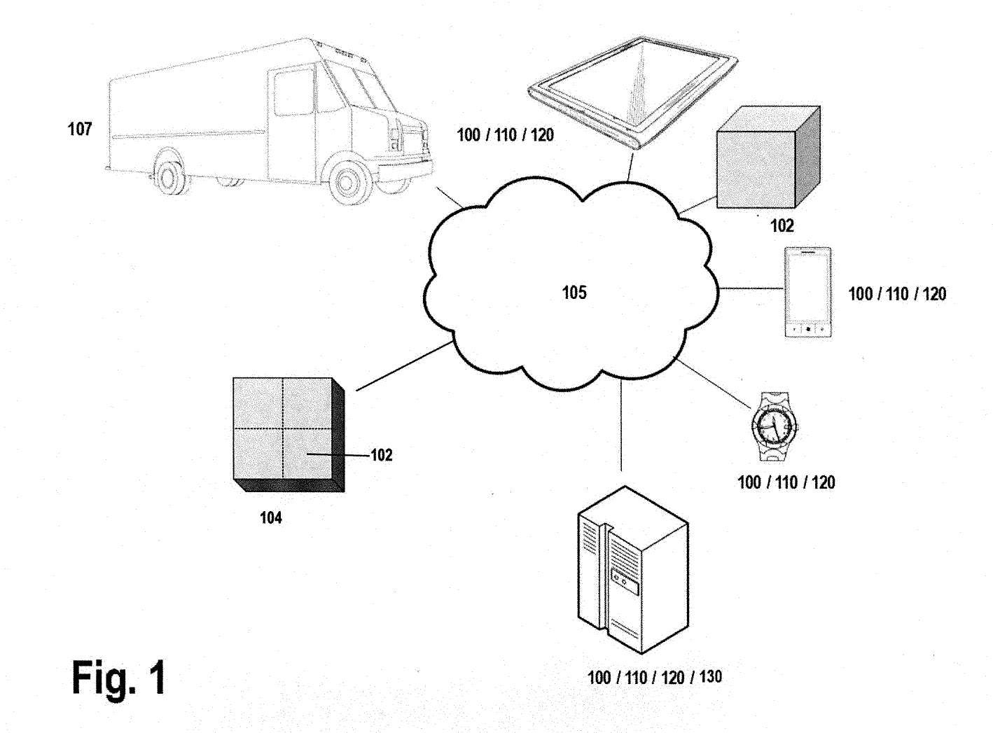

FIG. 1 provides an illustration of an exemplary embodiment of the present invention. As shown in FIG. 1, this particular embodiment may include one or more computing node entities 100, one or more shipment units 102, one or more shipment units 104 comprising one or more shipment units 102 therein, one or more networks 105, one or more vehicles 107, one or more transaction computing entities 110 (e.g., handheld and/or mobile computing entities, internet of things (IoT) enabled shipment units 102 and/or associated shipment units 104, and/or the like), one or more user computing entities 120, one or more financial services computing entities 130, and/or the like. Each of these components, entities, devices, systems, and similar words used herein interchangeably may be in direct or indirect communication with, for example, one another over the same or different wired or wireless networks and may collectively form one or more a distributed ledger databases (e.g., blockchains) for enabling autonomous matching of a shipment unit to service offers, tracking various transactions and/or activities, and/or the like. As discussed herein, certain of the computing entities (e.g., computing nodes 100, networks 105, and/or transaction computing entities 110) may be in electronic communication with one or more third party distributed ledgers (e.g., Bitcoin, Ethereum, Litecoin, Ripple, Dogecoin, and/or the like). Additionally, while FIG. 1 illustrates the various system entities as separate, standalone entities, the various embodiments are not limited to this particular architecture.

### 1. Exemplary Distributed Ledger System (e.g., Blockchain)

In certain embodiments, a distributed ledger system may store information/data indicative of various transactions occurring between multiple computing entities (e.g., multiple transaction computing entities). The distributed ledger system may be embodied as a blockchain ledger system, comprising a plurality of “blocks” each representing a record or log of discrete transactions occurring between any number of computing entities. Each block may comprise information/data linking to a previously-generated block, thereby providing a complete chain between the generation of information/data stored in the distributed ledger and the later use of the same information/data (e.g., to establish a complete and immutable chain-of-possession of information/data).

In various embodiments, the information/data stored in the various blocks may be encrypted, hashed, or otherwise protected from unauthorized access (e.g., read access, write access, and/or delete access). As just one non-limiting example, information stored in the various blocks may be irreversibly hashed, such that the hashed information/data may be used to verify the authenticity of transactions, but the hashed data may not be reverse-engineered to ascertain substantive information based on the hashed information alone. Moreover, information/data transmitted between various computing entities may be encrypted (e.g., using public/private key pairs to digitally sign and/or verify data) such that blocks/transactions stored within the block chain may be verified by multiple computing nodes 100 having access to the public and private keys. Upon verification of the information/data to be stored in the blockchain, the information/data may be hashed and stored as noted herein.

The distributed ledger system may comprise one or more, Bitcoin-based blockchains, such as Ethereum-based blockchains, Hyperledger blockchains, Quroum, Corda and/or the like. The distributed ledger system may incorporate a single blockchain configured for storing all transactions therein, or the distributed ledger system may comprise a plurality of blockchains, wherein each blockchain is utilized to store information/data indicative of a particular type of transaction. For example, a first blockchain may be configured to store shipment unit shipping/tracking information/data, and a second blockchain may be configured to store value transfer information/data (e.g., via a virtual currency). Accordingly, various embodiments may comprise and/or utilize digital currency/assets represented by ledger entries. Such digital currency/assets (e.g., Bitcoin, Ether, and/or the like) may itself have value that may be exchanged for various shipment units, services, and/or the like. Such digital currency/assets thus may be utilized as a currency in various transactions. Moreover, various embodiments may utilize and/or comprise various digital currencies/assets that may be exchanged for shipment units and/or information/data having a defined value.

The distributed ledger system may be stored in and/or by one or more computing nodes in a complete or partial form. A node can include, among other things, a computing device, mobile computing device and/or IoT enabled device (e.g. a package, container, etc. in the supply chain), by way of example. Each computing node may store a partial or complete copy of the one or more blockchains, and may be utilized for backup protection and/or transaction verification purposes. The distributed ledger system may be publicly accessible, and may be distributed among a plurality of commercial computing entities (e.g., servers), user computing entities (e.g., desktop computers, laptop computers, and/or the like), and/or the like. However, in certain embodiments, the distributed ledger system may be privately accessible, and may be stored by one or more computing nodes controlled by a single entity. In the latter embodiments, access to information/data stored in the distributed ledger may be limited to users having defined credentials (e.g., a private key, a passcode, and/or the like). In certain embodiments, information/data stored in the distributed ledger system may be hashed, encrypted, or otherwise protected from unauthorized access (e.g., read access and/or write access). The substantive information/data stored in the distributed ledger system may be accessible utilizing a private key to decrypt the stored information/data, or the substantive information/data may be inaccessible based on information/data stored in the distributed ledger.

In various embodiments, each block of a blockchain stored in the distributed ledger may comprise shipment unit-identifying information (e.g., shipment unit information/data), and may represent a shipping/tracking event for a corresponding shipment unit. For example, each time a shipment unit is scanned within a carrier's transportation network, each time the shipment unit is transferred from one shipping entity to another shipping entity, and/or the like, the distributed ledger system may be configured to generate a new block providing information/data indicative of the transaction. In certain embodiments, each block may comprise at least a portion of the shipment unit information/data, thereby providing a link back to a prior block representing a transaction involving the same shipment unit information/data.

### 2. Exemplary Computing Node Entity

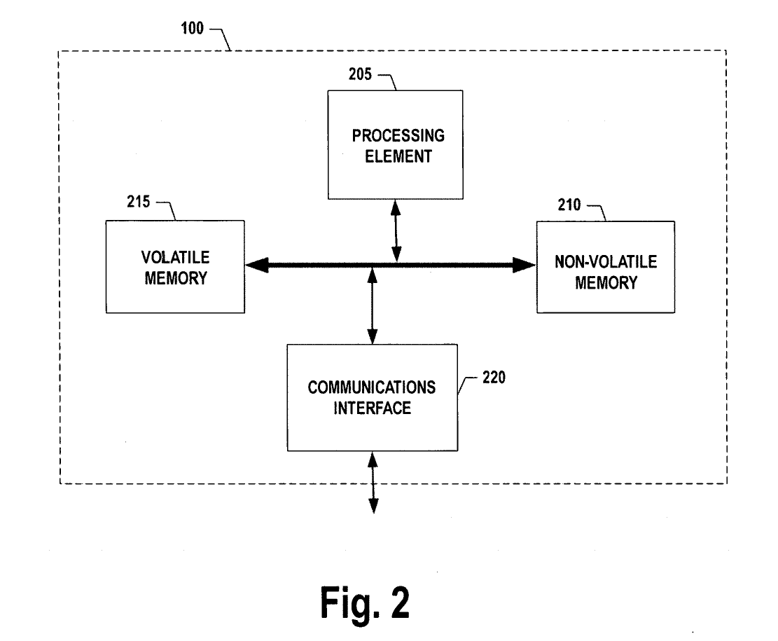

FIG. 2 provides a schematic of a computing node entity 100 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In an example embodiment, the computing node entity 100 may provide one or more nodes in various distributed ledger and/or blockchain data structures. For example, the blockchain data structures may correspond to one or more service offer databases, one or more selected service offer databases, one or more transportation databases, and/or the like. In an example embodiment, the computing node entity 100 may be embodied by a network of nodes and/or may provide one or more nodes of a network. In an example embodiment, the network may be configured to estimate and/or predict the number of nodes required for completing the functions of the network (e.g., receiving shipment unit information/data and matching shipment units and/or associated shipment units to service offers, receiving and storing service offers, storing selected service offers, receiving and storing transportation information/data, determining ratings, facilitating payments for transporting shipment units and/or associated shipment units, and/or the like) for a particular day based on historical function volume information/data. The historical function volume information/data may be determined based on one or more blockchain data structures for which the computing node entity 100 provides at least one node.

As indicated, in one embodiment, the computing node entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the computing node entity 100 may communicate with transaction computing entities 110, user computing entities 120, financial services computing entity 130, and/or the like.

As shown in FIG. 2, in one embodiment, the computing node entity 100 may include or be in communication with one or more processing elements 205 (also referred to as processors, processing circuitry, processing device, and/or similar terms used herein interchangeably) that communicate with other elements within the computing node entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the computing node entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases (e.g., service offer databases, one or more selected service offer databases, one or more transportation databases), database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a collection of records or data and/or a structured collection of records or data that is stored in a computer-readable storage medium, such as a relational database, hierarchical database, network database, distributed ledger, blockchain, model, network model, relational model, entity—relationship model, object model, document model, semantic model, graph model, and/or the like.

In one embodiment, the computing node entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases (e.g., service offer databases, one or more selected service offer databases, one or more transportation databases), database instances, database management systems, data, applications, programs, program modules, scripts, source code, object code, byte code, compiled code, interpreted code, machine code, executable instructions, and/or the like may be used to control certain aspects of the operation of the logistics service provider/carrier/transporter computing entity 100 with the assistance of the processing element 205 and operating system.

As indicated, in one embodiment, the computing node entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing node entity 100 may be configured to communicate via wireless external communication networks using any of a variety of protocols, such as general packet radio service (GPRS), Universal Mobile Telecommunications System (UNITS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Bluetooth protocols, Wibree, Home Radio Frequency (HomeRF), Simple Wireless Abstract Protocol (SWAP), wireless universal serial bus (USB) protocols, and/or any other wireless protocol.

Although not shown, the computing node entity 100 may include or be in communication with one or more input elements, such as a keyboard input, a mouse input, a touch screen/display input, motion input, movement input, audio input, pointing device input, joystick input, keypad input, and/or the like. The computing node entity 100 may also include or be in communication with one or more output elements (not shown), such as audio output, video output, screen/display output, motion output, movement output, and/or the like.

In one embodiment, the computing node entity 100 may include various payment features and functionalities. Payments (received or paid) may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, BlueTooth low energy (BLE), and various other contactless payment systems. Further, such payment technologies may include PayPal Beacon, Booker, Erply, Leaf, Leapset, Micros, PayPal Here, Revel, ShopKeep, TouchBistro, Vend, and/or the like. In an example embodiment, the computing node entity 100 may interact, communicate, and/or interface with one or more financial services computing entities 130 (e.g., via network 105) to perform various payment features and functionalities.

As will be appreciated, one or more of the computing node entity's 100 components may be located remotely from other computing node entity 100 components, such as in a distributed system. Furthermore, one or more of the components may be combined and additional components performing functions described herein may be included in the computing node entity 100. Thus, the computing node entity 100 can be adapted to accommodate a variety of needs and circumstances. As will be recognized, these architectures and descriptions are provided for exemplary purposes only and are not limiting to the various embodiments.

### 3. Exemplary Vehicle

In various embodiments, the term vehicle 107 is used generically. For example, a logistics service provider/carrier/transporter vehicle 107 may be a manned or an unmanned tractor, a truck, a car, a motorcycle, a moped, a Segway, a bicycle, a golf cart, a hand truck, a cart, a trailer, a tractor and trailer combination, a van, a flatbed truck, a vehicle, a drone, an airplane, a helicopter, a boat, a barge, and/or any other form of object for moving or transporting people and/or shipment units and/or associated shipment units (e.g., one or more packages, bags, containers, loads, crates, shipment units banded together, vehicle parts, pallets, drums, the like, and/or similar words used herein interchangeably). In one embodiment, each vehicle 107 may be associated with a unique vehicle identifier (such as a vehicle ID) that uniquely identifies the vehicle 107. The unique vehicle ID (e.g., trailer ID, tractor ID, vehicle ID, and/or the like) may include characters, such as numbers, letters, symbols, and/or the like. For example, an alphanumeric vehicle ID (e.g., “AS”) may be associated with each vehicle 107. In another embodiment, the unique vehicle ID may be the license plate, registration number, or other identifying information assigned to the vehicle 107. As noted above, in instances where the vehicle is a logistics service provider/carrier/transporter vehicle, the vehicle may be a self-driving delivery vehicle, a remotely operated delivery vehicle, and/or the like. Thus, for the purpose of the present disclosure, the term driver of a delivery vehicle may be used to refer to a logistics service provider/carrier/transporter personnel who drives a delivery vehicle and/or delivers shipment units and/or associated shipment units therefrom, an autonomous system configured to deliver shipment units and/or associated shipment units (e.g., a robot configured to transport shipment units and/or associated shipment units from a vehicle to a service point such as a customer's front door or other service point), and/or the like.

Various computing entities, devices, and/or similar words used herein interchangeably can be associated with the vehicle 107, such as a data collection device or other computing entities. In general, the terms computing entity, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, sensors (thermal, infrared, ultrasonic, ultraviolet, radiation, lock and others), key fobs, RFID tags, ear pieces, smart speakers, devices with intelligent personal assistant, scanners, televisions, dongles, cameras, voice recorders, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The data collection device may collect telematics data (including location data) along with other sensor data and transmit/send the data to the mobile computing entity, the mapping computing entity, and/or various other computing entities via one of several communication methods.

In one embodiment, the data collection device may include, be associated with, or be in wired or wireless communication with one or more processors (various exemplary processors are described in greater detail below), one or more location-determining devices or one or more location sensors (e.g., Global Navigation Satellite System (GNSS) sensors), one or more telematics sensors, one or more real-time clocks, a J-Bus protocol architecture, one or more electronic control modules (ECM), one or more communication ports for receiving telematics data from various sensors (e.g., via a CAN-bus), one or more communication ports for transmitting/sending data, one or more RFID tags/sensors, one or more power sources, one or more data radios for communication with a variety of communication networks, one or more memory modules, and one or more programmable logic controllers (PLC). It should be noted that many of these components (including cameras and voice recorders) may be located in the vehicle 107 but external to the data collection device.

In one embodiment, the one or more location sensors, modules, or similar words used herein interchangeably may be one of several components in wired or wireless communication with or available to the data collection device. Moreover, the one or more location sensors may be compatible with GPS satellites, such as Low Earth Orbit (LEO) satellite systems, Department of Defense (DOD) satellite systems, the European Union Galileo positioning systems, Global Navigation Satellite systems (GLONASS), the Chinese Compass navigation systems, Indian Regional Navigational satellite systems, and/or the like. Furthermore, the one or more location sensors may be compatible with Assisted GPS (A-GPS) for quick time to first fix and jump starting the ability of the location sensors to acquire location almanac and ephemeris data, and/or be compatible with Satellite Based Augmentation System (SBAS) such as Wide Area Augmentation System (WAAS), European Geostationary Navigation Overlay Service (EGNOS), and/or MTSAT Satellite Augmentation System (MSAS), GPS Aided GEO Augmented Navigation (GAGAN) to increase GPS accuracy. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, triangulation may be used in connection with a device associated with a particular vehicle 107 and/or the vehicle's operator and with various communication points (e.g., cellular towers or Wi-Fi access points) positioned at various locations throughout a geographic area to monitor the location of the vehicle 107 and/or its operator. The one or more location sensors may be used to receive latitude, longitude, altitude, heading or direction, geocode, course, position, time, and/or speed data (e.g., referred to herein as telematics data and further described herein below). The one or more location sensors may also communicate with the mapping computing entity, the data collection device, mobile computing entity, and/or similar computing entities.

As indicated, in addition to the one or more location sensors, the data collection device may include and/or be associated with one or more telematics sensors, modules, and/or similar words used herein interchangeably. For example, the telematics sensors may include vehicle sensors, such as engine, fuel, odometer, hubometer, tire pressure, location, weight, emissions, door, and speed sensors. The telematics data may include, but is not limited to, speed data, emissions data, RPM data, tire pressure data, oil pressure data, seat belt usage data, distance data, fuel data, idle data, and/or the like (e.g., referred to herein as telematics data). The telematics sensors may include environmental sensors, such as air quality sensors, temperature sensors, and/or the like. Thus, the telematics data may also include carbon monoxide (CO), nitrogen oxides (NOx), sulfur oxides (SOx), Ethylene Oxide (EtO), ozone (O₃), hydrogen sulfide (H₂S) and/or ammonium (NH₄) data, and/or meteorological data (e.g., referred to herein as telematics data).

In one embodiment, the ECM may be one of several components in communication with and/or available to the data collection device. The ECM, which may be a scalable and subservient device to the data collection device, may have data processing capability to decode and store analog and digital inputs from vehicle systems and sensors. The ECM may further have data processing capability to collect and present telematics data to the J-Bus (which may allow transmission to the data collection device), and output standard vehicle diagnostic codes when received from a vehicle's J-Bus-compatible on-board controllers and/or sensors.

As indicated, a communication port may be one of several components available in the data collection device (or be in or as a separate computing entity). Embodiments of the communication port may include an Infrared data Association (IrDA) communication port, a data radio, and/or a serial port. The communication port may receive instructions for the data collection device. These instructions may be specific to the vehicle 107 in which the data collection device is installed, specific to the geographic area in which the vehicle 107 will be traveling, specific to the function the vehicle 107 serves within a fleet, and/or the like. In one embodiment, the data radio may be configured to communicate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like. Similarly, the customer computing entity 110 may operate in accordance with multiple wired communication standards and protocols, such as those described above with regard to the computing node entity 100 via a network interface.

### 4. Exemplary Shipment Unit

In various embodiments, a shipment unit 104 may comprise one or more wireless network interface devices to provide a “smart” shipment unit, such as the shipments/parcels described in co-pending U.S. patent application Ser. No. 15/623,989, filed Jun. 15, 2017, the contents of which are incorporated herein by reference in their entirety.

A shipment unit 104 may be any tangible and/or physical object configured for containing/enclosing/grouping with one or more other associated shipment units 102. Such shipment units 104 may be picked up and/or delivered by a logistics service provider/carrier/transporter, for example, via one or more carrier service levels, such as Same Day Air, Same Day Ground, Next Day Air, Next Day Ground, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like.

In one embodiment, a shipment unit 104 may comprise one or more packages, bags, containers, loads, crates, or any other object (e.g., one or more associated shipment units 102) grouped or secured together, vehicle parts, pallets, drums, the like, and/or similar words used herein interchangeably. The shipment unit 104 may enclose, be grouped with, be bundled to (“associated with”) another shipment unit 102 (e.g., a shipped object) that itself may be tracked separately and/or in parallel with the shipment unit 104. Such shipment units 104 may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes.

For example, the shipment unit 104 may be configured to communicate with one or more devices (e.g., computing entities) located at one or more locations (e.g., a shipper location, a carrier location, and/or a recipient/consignee location) using a short/long range communication technology, as described in co-pending U.S. patent application Ser. No. 15/348,189, filed on Nov. 11, 2016 and incorporated herein by reference in its entirety. Further, such shipment units 104 may have the capabilities and components of the described with regard to the computing nodes 100, networks 105, vehicles 107, transaction computing entities 110, user computing entities 120, financial services computing entities 130, and/or the like. For example, the shipment unit 104 may be configured to store shipment unit information/data.

In an example embodiment, the computing node entity 100 may treat the shipment unit and/or associated shipment unit information/data and/or a portion thereof as a bid for transporting the shipment unit 104 and/or associated shipment unit 102. In an example embodiment, the shipment unit 104 may comprise a processor, memory, a communication interface, antenna, and/or the like. In example embodiments, the shipment unit information/data may comprise one or more of a consignee name/identifier, a shipment identifier, a service point (e.g., delivery location/address, pick-up location/address), instructions for delivering the shipment unit, a shipment unit delivery authorization code, special handling instructions, transportation preferences, payment information/data for paying for transportation of the shipment unit 104 and/or associated shipment unit 102, information/data indicating the content of the shipment unit 104 (e.g., indicating one or more shipment units 102 associated with the shipment unit 104, a product class, UPC, shipment unit name, shipment unit description, and/or the like), requirements and/or preferences for how the shipment unit 104 is transported (e.g., by air, by land, and/or by sea; by truck or by train; through a particular region, state, city, country; not through a particular region, sate, city, country; and/or the like), preferred and/or required temperature or temperature range of the shipment unit 104 and/or one or more associated shipment units, preferred and/or required maximum vibration level, information/data regarding if a device is present at the service point (e.g., a recipient location), and/or the like.

In this regard, in some example embodiments, a shipment unit 104 may communicate send “to” address information/data, received “from” address information/data, unique identifier codes, and/or various other information/data. In one embodiment, each shipment unit 104 may include a shipment unit/shipment identifier, such as an alphanumeric identifier. Such shipment unit/shipment identifiers may be represented as text, barcodes, tags, character strings, Aztec Codes, MaxiCodes, Data Matrices, Quick Response (QR) Codes, matrix barcodes or two-dimensional barcodes, electronic representations, and/or the like. A unique shipment unit/shipment identifier (e.g., 123456789) may be used by the carrier to identify and track the shipment unit 104 as it moves through the carrier's transportation network. Further, such shipment unit/shipment identifiers can be affixed to shipment units 104 by, for example, using a sticker (e.g., label) with the unique shipment unit/shipment identifier printed thereon (in human and/or machine readable form) or, an RFID tag with the unique shipment unit/shipment identifier stored therein, and/or other onboard computing entities operating as IoT enabled modules provided on the shipment unit. Alternatively or in addition, single photograph/image, series of photographs/images, movie/film taken at various or specific wavelength and comprising at least a portion of the enclosing shipment unit 104 may be stored in a digital form on a computer, servers, system, and/or the like and can be used to identify the shipment unit/shipment 104.

In various embodiments, packaging materials (e.g., boxes, envelopes, padded envelopes, sleeves, and/or the like) utilized for the shipment unit 104 may incorporate the one or more electrical components, including a power supply, therein. The power supply may be embodied as a battery, such as a lithium battery, that may be incorporated into the packaging materials. In certain embodiments, the battery may be printed onto the packaging materials (e.g., as a portion of a printed label). In various embodiments, the one or more electrical components may be configured to automatically activate upon sealing the packaging materials. For example, the packaging materials may comprise one or more electronic contacts (e.g., conductors) embedded, printed, and/or the like in one or more portions of the packaging materials, such that the electronic contacts collectively form a complete, closed circuit with one or more onboard computing components (e.g., batteries, processors, memory storage areas, wireless receivers (e.g., RFID receivers, BLE receivers, Wi-Fi receivers, and/or the like), wireless transmitters (e.g., RFID transmitters (active or passive), BLE transmitters, Wi-Fi transmitters, and/or the like), and/or the like). In certain embodiments, the electronic contacts may comprise printed conductors (e.g., 3-D printed conductors, inkjet printed conductors, and/or the like), such as conductive inks, sintered conductive materials, semi-conductive materials, and/or the like. When the packaging materials are closed, the electronic contacts enable current to flow between the onboard battery and the onboard computing components such that the onboard computing components are active (e.g., able to transmit and/or receive information/data).

Moreover, in certain embodiments the enclosing shipment unit 104 may comprise one or more environmental sensors configured to detect a condition of the enclosing shipment unit 104. For example, the shipment unit 104 may comprise temperature sensors, humidity sensors, accelerometers (to detect impacts and/or drops), and/or the like. As discussed herein, the one or more sensors within the shipment unit 104 may be utilized to determine whether the shipment unit conditions remained consistent with applicable shipping rules, thereby enabling the use of condition-based smart contracts as discussed herein.

In certain embodiments, shipment units (e.g., shipment units 102) contained within an enclosing shipment unit 104 may be wirelessly connected, and may be configured to provide wireless connectivity functionality for the enclosing shipment unit 104 while it is being transported by a carrier. For example, an electronic device being shipped may comprise a wireless transmitter (e.g., an RFID tag), a power supply, an on-board memory, and/or the like that may be configured to broadcast shipment unit information/data while the enclosed shipment unit 102 remains packaged within the enclosing shipment unit 104.

In certain embodiments, the wireless connectivity components may be disconnected and/or deactivated once the shipment unit 102 is removed from the enclosing shipment unit 104. For example, the wireless connectivity components may be embodied as a separate object placed within the enclosing shipment unit 104 (e.g., secured relative to the packaged or enclosed shipment unit); the wireless connectivity components may be embedded within the shipment unit (e.g., shipment unit 102); the wireless connectivity components may form a functional part of the shipment unit, and the shipment-specific functionality may be deactivated upon removal from the enclosing shipment unit 104, and/or the like.

In various embodiments, shipment units 104 may be associated with shipment unit information/data comprising information/data specific to the particular shipment unit. The shipment unit information/data may comprise information/data regarding an intended shipping route for the shipment unit 104 (e.g., an origin, destination, and/or the like), information/data regarding the contents of the shipment unit 104 (e.g., identifying one or more other shipment units stored within the shipment unit), information/data identifying shipping requirements for the shipment unit 104 (e.g., a carrier service level, temperature requirements, humidity requirements, shock requirements, and/or the like). As discussed herein, the shipping requirements for a shipment unit 104 may be utilized to automatically apply various smart contracts upon determining whether shipping requirements have been met. Moreover, the shipment unit information/data may comprise updated control identifiers, as discussed herein, providing information/data indicative of a current identity of an entity, individual, carrier, and/or entity in control (e.g., possession) of the shipment unit 104 and/or location of the shipment unit 104. For example, the control identifier may indicate that a particular shipment unit 104 is located on a particular delivery vehicle 107, at a particular carrier sort location, at a pick-up/transfer/delivery location, and/or the like. Moreover, the shipment unit information/data may comprise linking information data configured for use in a blockchain environment, to link the shipment unit 104 information/data of a particular “block” to previously generated transaction/blocks relating to the same and/or different shipment unit information/data.

### 4. Exemplary Shipment Unit

A shipment unit 102 may be any tangible and/or physical object. Such shipment units 102 may be picked up and/or delivered by a logistics service provider/carrier/transporter. In one embodiment, a shipment unit 102 may be or be enclosed, contained, and/or packaged in one or more shipment units (e.g., shipment unit 104) for transportation along at least a portion of the transportation of the shipment unit 102 from an origin location to a destination location. Such shipment units 102 may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. Further, such shipment units 102 may have the capabilities and components of the described with regard to the computing node entities 100, networks 105, vehicles 107, shipment units 104, transaction computing entities 110, user computing entities 120, financial services computing entities 130, and/or the like.

For example, the shipment unit 102 may be configured to store shipment unit information/data. In an example embodiment, the computing node entity 100 may treat the shipment unit information/data and/or a portion thereof as a bid for transporting the shipment unit. In an example embodiment, the shipment unit 102 may comprise a processor, memory, a communication interface, antenna, and/or the like. In example embodiments, the shipment unit information/data may comprise one or more of a consignee name/identifier, a shipment unit identifier, a service point (e.g., delivery location/address, pick-up location/address), instructions for delivering the shipment unit, a shipment unit delivery authorization code, special handling instructions, transportation preferences, payment information/data for paying for transportation of the shipment unit, information/data indicating the content of the shipment unit (e.g., a product class, UPC, shipment unit name, shipment unit description, and/or the like), requirements and/or preferences for how the shipment unit is transported (by air, by land, and/or by sea; by truck or by train; through a particular region, state, city, country; not through a particular region, sate, city, country; and/or the like), preferred and/or required temperature or temperature range of the shipment unit, preferred and/or required maximum vibration level, information/data regarding when and/or where the shipment unit is to be added to and/or removed from another shipment unit or package, and/or the like.

In this regard, in some example embodiments, a shipment unit may communicate send “to” address information/data, received “from” address information/data, unique identifier codes, and/or various other information/data. In one embodiment, each shipment unit may include a shipment unit/shipment identifier, such as an alphanumeric identifier. Such shipment unit/shipment identifiers may be represented as text, barcodes, tags, character strings, Aztec Codes, MaxiCodes, Data Matrices, Quick Response (QR) Codes, matrix barcodes or two-dimensional barcodes, electronic representations, and/or the like. A unique shipment unit/shipment identifier (e.g., 123456789) may be used by the carrier to identify and track the shipment unit as it moves through the carrier's transportation network. Further, such shipment unit/shipment identifiers can be affixed to shipment units by, for example, using a sticker (e.g., label) with the unique shipment unit/shipment identifier printed thereon (in human and/or machine readable form) or an RFID tag with the unique shipment unit/shipment identifier stored therein. Alternatively or in addition, single photograph/image, series of photographs/images, movie/film taken at various or specific wavelength and comprising at least a portion of the shipment unit may be stored in a digital form on a computer, servers, system, and/or the like and can be used to identify the shipment unit/shipment 102.

### 5. Exemplary Transaction Computing Entity

In an example embodiment, a transaction computing entity 110 is operated by and/or on behalf of a logistics service provider, carrier, transporter, a consignee, a consignor, and/or the like (referred to collectively as carriers herein). A logistics service provider may be a traditional carrier, such as United Parcel Service, FedEx, DHL, courier services, the United States Postal Service (USPS), Canadian Post, freight companies (e.g. truck-load, less-than-truckload, rail logistics service providers, air logistics service providers, ocean logistics service providers, etc.), and/or the like. However, a logistics service provider/carrier/transporter may also be a nontraditional logistics service provider, such as Amazon, Google, Uber, ride-sharing services, crowd-sourcing services, retailers, and/or the like. In particular, a logistics service provider/carrier/transporter may be an entity that transports one or more shipment units and/or associated shipment units along at least a portion of the way from the shipment unit and/or associated shipment unit's origin to its destination. In an example embodiment, a consignor may be shipper of a shipment unit. In an example embodiment, a consignee may be an intended recipient of a shipment unit.

In an example embodiment, transaction computing entities 110 may be utilized to perform low-level transaction functions, such as generating and/or transmitting data to initialize a transaction to be recorded via a distributed ledger (e.g., blockchain) or other transactional recordation system. In an example embodiment, a transactional computing entity 110 may be located at and/or transported to physical location where a transaction is to be consummated. Various transactional computing entities 110 may be stationary in nature (e.g., desktop computing entities, gaming consoles, servers, and/or the like). Moreover, in certain embodiments, transaction computing entities 110 may be embodied as Internet of Things (IoT) enabled devices, shipment units 104, shipment units 102, and/or the like. As discussed herein, the IoT enabled shipment units 104 may be network connected and may be configured to generate, receive, and/or transmit information/data to one or more additional computing entities (e.g., another transaction computing entity 110, vehicle 107, and/or the like) to initialize transactions, to memorialize transactions, and/or the like. Information/data generated/received/transmitted by the IoT shipment units 104 and/or associated shipment units 102 may be recorded via a distributed ledger (e.g., blockchain), as discussed herein.

In an example embodiment, a transaction computing entity 110 may be a node storing one or more distributed ledger and/or blockchain data structures. For example, the distributed ledger and/or blockchain data structures may correspond to one or more service offer databases, one or more selected service offer databases, one or more transportation databases, and/or the like. In an example embodiment, a transaction computing entity 110 may be lightweight node of one or more distributed ledger and/or blockchain data structures. In an example embodiment, a transaction computing entity 110 may comprise and/or operate a program configured to interface with a distributed ledger and/or blockchain system and/or network. For example, the transaction computing entity 110 may provide information/data to be included and/or encoded within one or more distributed ledgers and/or blockchains and/or may access information/data stored in one or more distributed ledgers and/or blockchains.

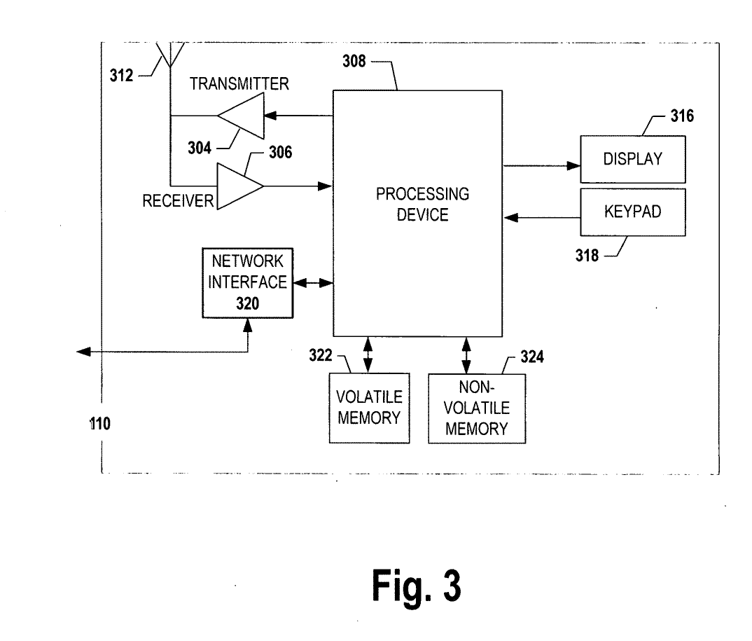

FIG. 3 provides an illustrative schematic representative of a transaction computing entity 110 according to one example embodiment. In one embodiment, a transaction computing entity 110 may include one or more components that are functionally similar to those of the computing node entity 100, shipment unit 102, shipment unit 104, vehicle 107, financial services computing entity 130, and/or the like. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, sensors (thermal, infrared, ultrasonic, ultraviolet, radiation, lock and others), key fobs, RFID tags, ear pieces, smart speakers, devices with intelligent personal assistant, scanners, cameras, voice recorders, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the transaction computing entity 110 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the transaction computing entity 110 may be capable of operating with one or more air interface standards, communication protocols, modulation types, and access types. More particularly, the transaction computing entity 110 may operate in accordance with any of a number of wireless communication standards and protocols, such as those described above with regard to the computing node entity 100. In a particular embodiment, the transaction computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like. Similarly, the transaction computing entity 110 may operate in accordance with multiple wired communication standards and protocols, such as those described above with regard to the computing node entity 100 via a network interface 320.

Via these communication standards and protocols, the transaction computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The transaction computing entity 110 can also download changes, add-ons, and updates, for instance, to its firmware, software (e.g., including executable instructions, applications, program modules), and operating system.

According to one embodiment, the transaction computing entity 110 may include a location determining aspects, device, module, functionality, and/or similar words used herein interchangeably. For example, the transaction computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data can be collected using a variety of coordinate systems, such as the DD; DMS; UTM; UPS coordinate systems; and/or the like.

Alternatively, the location information can be determined/identified by triangulating the transaction computing entity's 110 position in connection with a variety of other systems, including cellular towers, Wi-Fi access points, and/or the like. Similarly, the transaction computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine/identify the location of someone or something to within inches or centimeters.

The transaction computing entity 110 may also comprise a user interface (that can include a display 316 coupled to a processing element 308) and/or a user input/interaction interface (coupled to a processing element 308). For example, the user interface may be a user application, browser, graphical user interface, and/or similar words used herein interchangeably executing on and/or accessible via the customer computing entity 110 to interact with and/or cause display of information from the computing node entity 100, as described herein. The user input/interaction interface can comprise any of a number of devices allowing the transaction computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the transaction computing entity 110 and may include a full set of alphabetic keys or set of keys that may be activated to provide a full set of alphanumeric keys. In addition to providing input, the user input/interaction interface can be used, for example, to activate or deactivate certain functions, such as screen savers and/or sleep modes.

The transaction computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the transaction computing entity 110. As indicated, this may include a user application that is resident on the entity or accessible through a browser or other user interface for communicating with the computing node entity 100, and/or various other computing entities.

In another embodiment, the transaction computing entity 110 may include one or more components or functionality that are the same or similar to those of the computing node entity 100, as described in greater detail above. As will be recognized, these architectures and descriptions are provided for exemplary purposes only and are not limiting to the various embodiments.

In one embodiment, transaction computing entities 110 may be fixed with regard to their geographic locations, such as by being in fixed positions at school entrances, bus stops, mall entrances, aisles of a store, in classrooms, on playgrounds, at intersections, on light poles, in cafeterias or hallways, on bridges, and/or the like. In another embodiment, transaction computing entities 110 may be mobile with regard to their geographic locations. For example, one or more of the transaction computing entities 110 may be disposed on school buses, worn by school bus drivers, be attached to package delivery vehicles, attached to mobile shipping containers, affixed to shopping carts or wheelchairs, positioned in passenger vehicles or drones, and/or the like. As will be recognized, a variety of other approaches and techniques can be used to adapt to various needs and circumstances.

### 6. Exemplary Financial Services Computing Entity

In one embodiment, a financial services computing entity 130 may be operated by and/or on behalf of a financial services provider, such as a bank, credit union, automated clearing house (ACH), and/or the like. As will be recognized, payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, Bluetooth low energy (BLE), and various other contactless payment systems. Further, such payment technologies may include PayPal Beacon, Booker, Erply, Leaf, Apple Pay, Leapset, Micros, PayPal Here, Revel, ShopKeep, TouchBistro, Vend, and/or the like. The computing node entity 100 and/or the shipment unit 102 may communicate with the financial services computing entity 130 to facilitate payment of one or more logistics service providers for transportation of the shipment unit. In one embodiment, a financial services computing entity 130 may include one or more components that are functionally similar to those of the computing node entity 100, the transaction computing entity 110, customer computing entity 120, and/or the like.

For example, in one embodiment, each financial services computing entity 130 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, interface, and/or similar words used herein interchangeably executing on and/or accessible via the financial services computing entity 130 to interact with and/or cause display of information, as described herein. This may also enable the financial services computing entity 130 to communicate with various other computing entities, such as computing node entities 100, transaction computing entities 110, customer computing entity 120, shipment units 102, and/or various other computing entities. As will be recognized, these architectures and descriptions are provided for exemplary purposes only and are not limiting to the various embodiments.

### IV. Exemplary System Operation

As noted above, example embodiments provide for autonomous matching of a shipment unit to one or more service offers based on the shipment unit information/data corresponding to the shipment unit. For example, the shipment unit information/data, and/or a portion thereof, may be used as a bid for transporting the shipment unit. Example embodiments are configured to provide a verifiable and permanent record of service offers, selected service offers, shipment unit information/data, transportation information/data, settlement/payment information/data, and/or the like corresponding to one or more shipment units and/or associated shipment units.

### 1. Autonomous Matching of a Shipment Unit to Service Offers

As noted above, in various embodiments, the computing node entity 100 may store (e.g., in memory 210, 215) various information/data in one or more databases and/or other data storage structures. For example, the computing node entity 100 may store one or more service offer databases for storing one or more service offers, one or more transportation databases for storing transportation information/data, one or more shipment unit databases for storing shipment unit information/data and/or a portion thereof, one or more transaction databases for storing information/data related to one or more financial transactions regarding one or more shipment units and/or associated shipment units, one or more rating databases comprising rating information/data for one or more logistics service providers, and/or the like. In an example embodiment, one or more of the databases comprise distributed ledgers. In an example embodiment, one or more of the databases comprises a blockchain data structure. In an example embodiment, service offer, transportation, shipment unit, transaction, and/or rating information/data may be stored in one or more distributed ledger and/or blockchain data structures. In an example embodiment, a link to and/or hash of service offer, transportation, shipment unit, transaction, and/or rating information/data may be stored in one or more distributed ledger and/or blockchain data structures and the service offer, transportation, shipment unit, transaction, and/or rating information/data may be referred to and/or linked to in the distributed ledger and/or blockchain data structure and stored in a relational and/or non-relational database and/or another data storage structure.

In an example embodiment, the service offer, transportation, shipment unit, transaction, and/or rating information/data may be stored to the blockchain data structure in an encrypted form. For example, a transaction computing entity 110, and/or computing node entity 100 may encode the service offer, transportation, shipment unit, transaction, and/or rating information/data; a portion of the service offer, transportation, shipment unit, transaction, and/or rating information/data; a hash corresponding to and/or linked to the service offer, transportation, shipment unit, transaction, and/or rating information/data using a private key and/or symmetric key stored and/or accessible to the corresponding computing entity. In an example embodiment, the encrypting and/or providing computing entity (e.g., transaction computing entity 110 and/or computing node entity 100) may sign the information/data by encrypting the service offer, transportation, shipment unit, transaction, and/or rating information/data; a portion of the service offer, transportation, shipment unit, transaction, and/or rating information/data; a hash corresponding to and/or linked to the service offer, transportation, shipment unit, transaction, and/or rating information/data using the private and/or symmetric key. In an example embodiment, the private key is linked to a provider identifier, shipment unit identifier, associated shipment unit identifier, and/or the like. For example, a particular provider may only be able to write and/or read service offers comprising the provider identifier for the particular provider using the private and/or symmetric key corresponding to the provider identifier.

Thus, in example embodiments, access to service offer, transportation, shipment unit, transaction, and/or rating information/data may be controlled, at least in part, through the encryption/decryption of information/data using private/public and/or symmetric keys. In various embodiments, the computing node entity 100 may enact various other access control techniques in addition to and/or in place of the use of private/public and/or symmetric keys. For example, the computing node entity 100 may comprise a sub-system, module(s), and/or the like configured to and/or responsible for handling authentication and authorization, role-based, peer-to-peer, and/or other access control. For example, the computing node entity 100 (e.g., a matching sub-system, module(s), and/or the like of the computing node entity) may be the only entity allowed to access, read, and/or write both service offers and shipment unit information/data. For example, in an example embodiment, a transaction computing entity 110 operated by and/or on behalf of a consignee or consignor may not be provided with access to view specific details of service offers stored in the service offer database.

Similarly, in an example embodiment, a transaction computing entity 110 operated by and/or on behalf of a carrier may not be provided with access to view shipment unit information/data stored in the shipment unit database. Moreover, the provider computing entity 110 may only be able to access service offers corresponding with the provider identifier corresponding to the logistics service provider/carrier/transporter corresponding to the transaction computing entity 110. For example, various computing entities may be provided with various information/data stored in the one or more databases, blockchain data structures, and/or other data structures based on a need-to-know model. Thus, various embodiments provide a fair, manipulation resistant environment for matching shipment units and/or associated shipment units to be transported, based on the corresponding shipment unit information/data, to one or more service offers for transporting the shipment unit. Thus, private/public key, symmetrical, and/or other forms of encryption may be leveraged to ensure confidentiality of various types of information/data and to adhere to the need-to-know model. In an example embodiment, one or more transaction computing entities 110 may be provided with rate guidance in order to allow them to understand high level cost expectations. For example, in one embodiment, an average rate, range of rates and/or distribution of rates, and/or the like for a particular leg, set of legs, and/or the like may be provided to one or more transaction computing entities 110 to provide one or more customers and/or logistics service providers/carriers/transporters with a rate expectation, rate estimate, and/or high level rate expectation for the particular leg, set of legs, and/or the like.

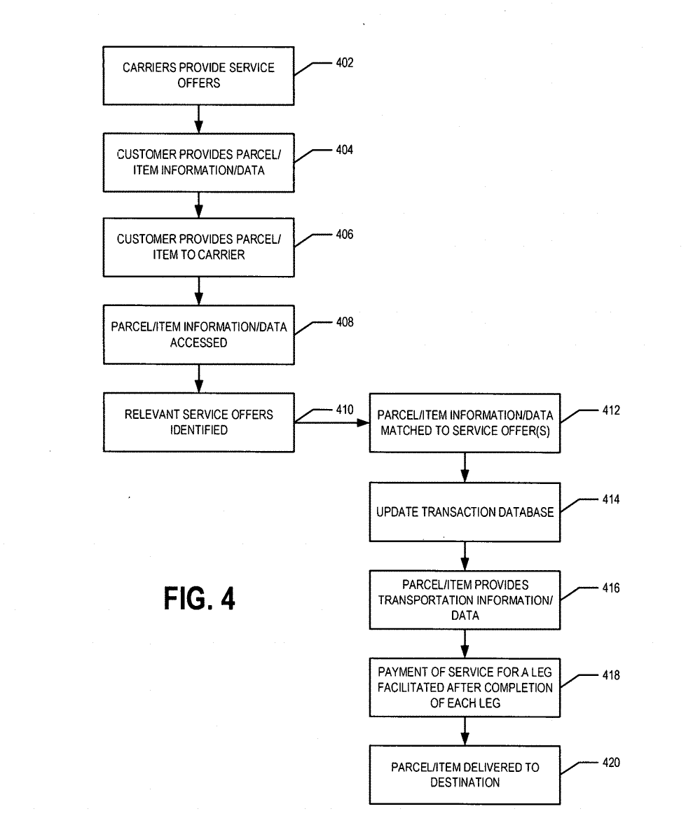

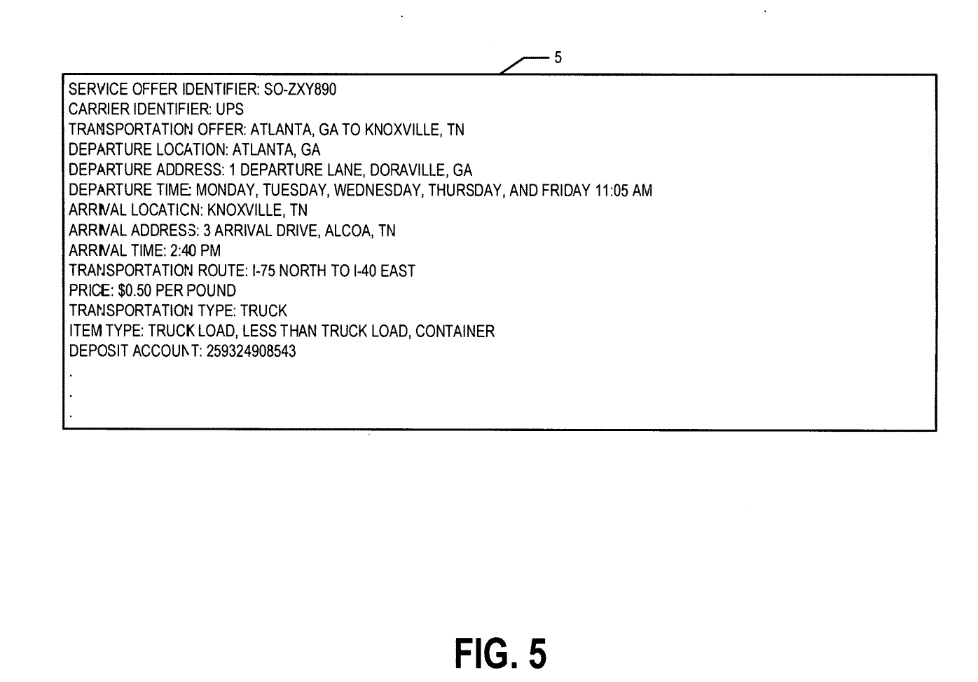

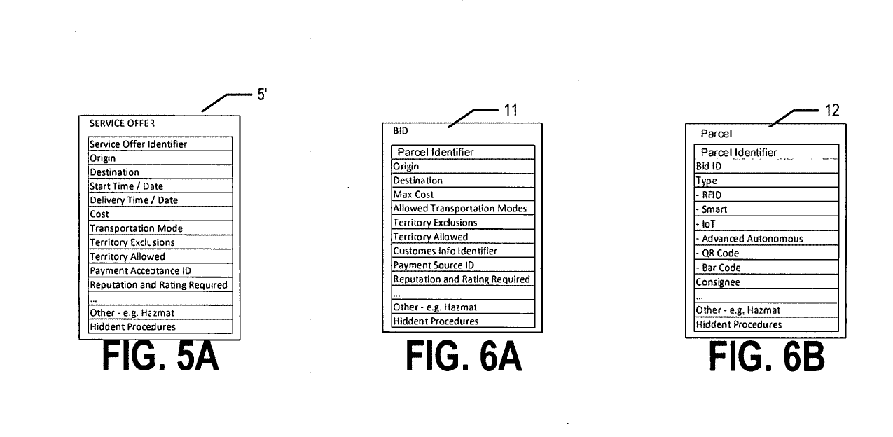

FIG. 4 provides a flowchart of various processes and procedures that may be completed in accordance with an example embodiment to provide transportation services. Starting at block 402, one or more logistics service providers/carriers/transporters provide one or more service offers. For example, the computing node entity 100 may receive one or more service offers generated and provided by one or more transaction computing entities 110. In an example embodiment, a service offer may be an offer to transport one or more shipment units from a first location to a second location. FIG. 5 illustrates an example service offer 5. The example service offer 5 comprises various service offer parameters/conditions, such as a service offer identifier configured to uniquely identify the service offer, a logistics service provider/carrier/transporter identifier configured to uniquely identify the logistics service provider/carrier/transporter providing the service offer, a departure location, departure address, departure time or time range, an arrival location, arrival address, arrival time or time range, transportation route, transportation type (e.g., land, air, sea, tractor trailer, train, boat, airplane, and/or the like), cost per unit of shipment unit weight and/or volume, cost per shipment unit, type of shipment units and/or associated shipment units (e.g., trailer load, less than trailer load, environment condition requirements, palletized loads, cargo containers, individual shipment units (e.g., single boxes and/or the like)), one or more shipment units packaged in another associated shipment unit, payment information/data (e.g., deposit account that payment for transportation of shipment units and/or associated shipment units should be deposited to), and/or the like. FIG. 5A illustrates an example data construct for a service offer information/data 5′.

In an example embodiment, an individual associated with the logistics service provider/carrier/transporter (e.g., an employee and/or agent of the logistics service provider/carrier/transporter) may provide the content of the service offer through a user interface of a transaction computing entity 110. In an example embodiment, an automated agent of the logistics service provider/carrier/transporter (e.g., an automated program operating on a transaction computing entity 110) may generate and provide one or more service offers. For example, one or more service offers may be directly transmitted (e.g., via network interface 320 and/or transmitter 304) to the computing node entity 100 from the transaction computing entity 110 and/or transmitted through one or more wired and/or wireless communications networks from the transaction computing entity 110 to the computing node entity 100. For example, the computing node entity 100 may receive one or more service offers via communications interface 220.

The computing node entity 100 may be configured to store the received service offer(s) in memory (e.g., volatile memory 215, non-volatile memory 210). In an example embodiment, the received service offer(s) may be stored to a service offer database. In an example embodiment, the service offer database may comprise one or more distributed ledger and/or blockchain data structures. For example, the computing node entity 100 may receive the service offer, identify related service offers within the service offer database, distributed ledger, and/or blockchain(s), and generate a hash of one or more records or blocks corresponding to related service offers. In an example embodiment, the related service offers may be service offers provided by the same logistics service provider/carrier/transporter (e.g., comprising the same logistics service provider/carrier/transporter identifier).

In various embodiments, the related service offers may be service offers corresponding to the same geographical area, same transportation route (at least in part), having the same arrival location, having the same departure location, having the same avoided regions, and/or the like, and/or some combination thereof. The generated hash may then be included as part of the new record or block saved to the distributed ledger and/or blockchain data structure including the new service offer (e.g., as a hash or Merkle root included in, for example, the block or record header).

In an example embodiment, the transaction computing entity 110 stores and/or has access to a private key used to submit service offers comprising the logistics service provider identifier that identifies the corresponding logistics service provider. For example, a service offer comprising a logistics service provider identifier may need to be signed and/or encrypted using a private key corresponding to the logistics service provider identifier for the service offer to be accepted and/or stored to the service offer database and/or blockchain(s). The computing node entity 100 may store and/or have access to one or more public or private keys configured for reading the service offers provided by one or more logistics service providers/carriers/transporters.

In an example embodiment, computing node entity 100 may not have permission for writing to the service offer database. In an example embodiment, computing node entity 100 may write the service offer to the service offer database but may have permission for modifying the service offer.

At block 404 of FIG. 4, a customer (e.g., consignor and/or consignee) provides shipment unit information/data corresponding to a shipment unit. For example, a customer operating a transaction computing entity 110 may provide at least a portion of the shipment unit information/data through a user interface thereof.

In an example embodiment, the shipment unit information/data may be automatically generated by the transaction computing entity 110 (e.g., via processing device 308), for example, in the case of an automated order fulfillment system and/or an order fulfilled through automatic re-order, and/or the like.

In an example embodiment, the shipment unit 102 and/or associated shipment unit 104 may be a shipment unit having smart and/or autonomous shipment unit capabilities and the shipment unit itself may generate the shipment unit information/data. The shipment unit information/data may be transmitted (e.g., directly and/or through one or more wired and/or wireless networks) from the transaction computing entity 110 (e.g., operated by and/or on behalf of a customer, consignor, consignee, and/or the like) to the computing node entity 100 and/or the shipment unit 102 and/or associated shipment unit 104. For example, if the shipment unit 102 and/or associated shipment unit 104 comprises a communication enabled device, a processing element, and memory, the shipment unit information/data may be stored by the shipment unit 102 and/or associated shipment unit 104.

In an example embodiment, the transaction computing entity 110 may transmit the shipment unit information/data to the shipment unit 102 and/or associated shipment unit 104 using Bluetooth, Wi-Fi, infrared or radio protocol, near field communication (NFC) and/or some other communication protocol. The shipment unit 102 and/or associated shipment unit 104 may receive the shipment unit information/data through the communication interface thereof stored to the corresponding memory.

In another example embodiment, the shipment unit 102 and/or associated shipment unit 104 may comprise an RFID tag. The RFID tag may be encoded by and/or on behalf of the transaction computing entity 110 with at least a portion of the shipment unit information/data and at least a portion (e.g., the remainder of the shipment unit information/data, all of the shipment unit information/data, and/or the like) may be provided to the computing node entity 100 by the transaction computing entity 110. In another example embodiment, the customer (e.g., consignor may affix a sticker/label comprising a bar code or other machine and/or human readable indicia thereon.

In another example, a customer (e.g., consignor, shipper, and/or the like) may write on the shipment unit 102 and/or associated shipment unit 104 a human and/or machine readable indicia. The machine and/or human readable indicia may encode and/or comprise the shipment unit identifier corresponding to the shipment unit. The shipment unit information/data may then be retrievable from the shipment unit database (which comprises a distributed ledger and/or blockchain data structure, in one embodiment) based at least in part on the shipment unit identifier.

In another example, based on the shipment unit 102 and/or associated shipment unit 104 appearance, that is captured/provided by the transaction computing entity 110 (e.g., operated by a personnel of the logistics service provider/carrier/transporter, consignor, shipper, customer, and/or the like) and/or by vehicles 107 and relayed to the computing node entity 100, the shipment unit 102 and/or associated shipment unit 104 would be uniquely identified. The shipment unit information/data may then be retrievable from the shipment unit database and/or associated shipment unit database (which comprises a distributed ledger and/or blockchain data structure, in one embodiment) based on the appearance-based identification.

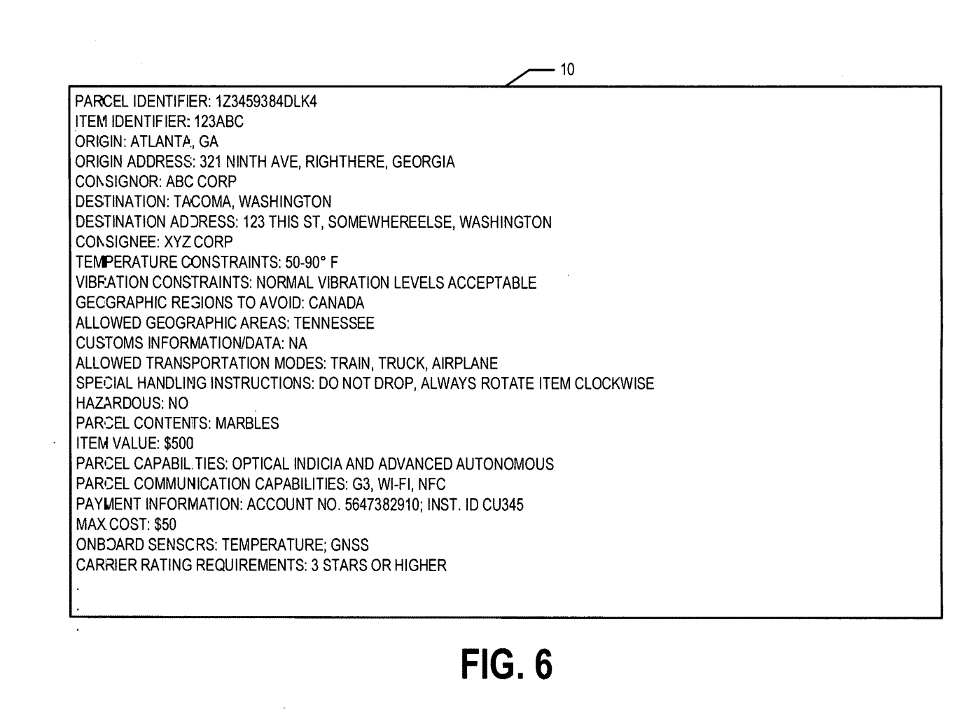

FIG. 6 shows an example user interface of the transaction computing entity 110 for providing shipment unit information/data 10. As noted above, the computing node entity 100 may use the shipment unit information/data as a bid for transporting the shipment unit, in various embodiments. In an example embodiment, the shipment unit information/data may be updated after (e.g., responsive to) the selection of the one or more service offers to incorporate information/data corresponding to the selected service offer(s). For example, FIG. 6A shows an example data construct for bid information/data 11 comprising shipment unit information/data and FIG. 6B shows an example data construct for shipment unit information/data 12 that has been updated to indicate and/or reflect the scheduled transportation of the shipment unit 102 and/or associated shipment unit 104 in accordance with the one or more selected service offers and/or the completion of transporting the shipment unit as indicated by the selected service offer(s).

In various embodiments, the shipment unit information/data may comprises a shipment unit identifier configured to uniquely identify the shipment unit. In an example embodiment, the shipment unit identifier may be configured to uniquely identify the shipment unit globally such that the shipment unit may be tracked through the transportation network of multiple logistics service providers based on the shipment unit identifier.

In various embodiments, the shipment unit information/data may comprise one or more logistics service provider-based shipment unit identifiers; a consignee name; consignee address; consignee account and/or profile identifier; consignee contact information/data (e.g., physical address, electronic address, phone number, and/or the like); delivery and/or destination address; pick-up and/or origin address; destination location; origin location; consignor name; consignor address; consignor account and/or profile identifier; consignor contact information/data (e.g., physical address, electronic address, phone number, and/or the like); delivery time frame (e.g., day(s) and/or range of days for delivery, maximum number of days the shipment unit should be in transit, and/or the like); a time and/or location when a shipment unit is to be formed from one or more other shipment units and/or divided into one or more different shipment units; payment account information/data for use in paying for the transportation of the shipment unit; a maximum amount that is to be spent on transporting the shipment unit from the origin to the destination; temperature constraints, requirements, and/or preferences for transporting and/or warehousing the shipment unit; vibration constraints, requirements, and/or preferences for transporting and/or warehousing the shipment unit; transportation route constraints, requirements, and/or preferences for transporting/warehousing the shipment unit; transportation mode (e.g., by land, by sea, by air, by tractor trailer, by train, by airplane, by cargo ship, and/or the like) constraints, requirements, and/or preferences for transporting the shipment unit; special handling instructions; relevant hazardous materials information/data; customs information/data; shipment unit value; information/data corresponding to transportation insurance purchased for the shipment unit; information/data identifying the contents of the shipment unit; information/data identifying the communication interfaces and/or protocols through which the shipment unit can communicate; shipment unit capabilities type; sensors onboard the shipment unit; logistics service provider constraints, requirements, and/or preferences for transporting the shipment unit; logistics service provider rating constraints, requirements, and/or preferences for transporting the shipment unit, and/or other constraints, requirements, and/or preferences for transporting and/or warehousing the shipment unit. In an example embodiment, each logistics service provider-based shipment unit identifier is configured to identify the shipment unit within the transportation network of a particular logistics service provider.

As noted above, different shipment units 102 and/or associated shipment units 104 may have different shipment unit capabilities. For example, a shipment unit 102 and/or associated shipment unit 104 may have optical indicia, RFID, smart, advanced autonomous, and/or various other capabilities. For example, a shipment unit having optical indicia capabilities may have machine and/or human readable indicia affixed thereto (e.g., via a label or sticker), written thereon, printed thereon, and/or the like. The optical indicia may be read, scanned, and/or the like by an optical scanner, using computer vision techniques, and/or the like. Reading, scanning, and/or the like the optical indicia may provide the transaction computing entity 110 with the shipment unit identifier and/or other shipment unit information/data.

As described above, the shipment unit identifier may be used to access additional shipment unit information/data within a shipment unit database (which in an example embodiment comprises one or more distributed ledger and/or blockchain structures), stored, for example, by a plurality of computing node entities 100. A shipment unit 102 and/or associated shipment unit 104 having RFID capabilities may have an RFID tag embedded therein and/or attached thereto. The RFID tag may encode the shipment unit identifier. The RFID tag may further encode other shipment unit information/data, in some embodiments. The RFID tag may be an active or passive RFID tag. Reading, scanning, and/or the like the RFID tag (e.g., using an RFID interrogator, RFID transceiver, RFID receiver, and/or the like) may provide the transaction computing entity 110 with the shipment unit identifier. In an example embodiment, reading, scanning, and/or the like the RFID tag may provide the transaction computing entity 110 with additional shipment unit information/data.

In an example embodiment, a shipment unit 102 and/or associated shipment unit 104 having smart shipment unit capabilities may comprise various circuit and/or computer elements. For example, a shipment unit 102 having smart capabilities may comprise one or more communications interfaces for communicating via one or more wireless protocols. The shipment unit 102 and/or associated shipment unit 104 with smart capabilities may comprise one or more sensors for measuring environmental conditions the shipment unit experiences (e.g., temperature, vibration, light brightness, and/or the like). In an example embodiment, a shipment unit 102 and/or associated shipment unit 104 with smart capabilities comprises a GNSS sensor for determining the geolocation of the shipment unit. The one or more communications interfaces may provide transmissions, notifications, alerts, messages, and/or the like comprising one or more measurements of environmental conditions and/or geolocation of the shipment unit to the computing node entity 100. In an example embodiment, the environmental conditions information/data and/or geolocation information/data are considered to be transportation information/data corresponding to the experience of the shipment unit during transportation of the shipment unit from the origin to the destination. The shipment unit 102 and/or associated shipment unit 104 with smart capabilities may further comprise memory configured for storing at least a portion of the shipment unit information/data, including the shipment unit identifier. The shipment unit 102 and/or associated shipment unit 104 with smart capabilities may be configured to provide the shipment unit identifier to the computing node entity 100 (and/or the transaction computing entity 110). In an example embodiment, any transmission, notification, alert, message, and/or the like provided by the shipment unit with smart capabilities that comprises transportation information/data (e.g., environmental conditions information/data, shipment unit geolocation information/data, and/or the like) also comprises the shipment unit identifier.

In an example embodiment, a shipment unit may have advanced autonomous capabilities. In an example embodiment, a shipment unit with advanced autonomous capabilities will be equipped with computer storage (e.g., memory), logic (e.g., processing elements and executable instructions configured to executed/processed by the processing elements and are stored in the computer storage), and wireless interfaces (e.g., Wi-Fi interface, broadband interface, cellular interface, and/or the like as described above), to interact with one or more computing node entities 100 and/or transaction computing entities 110.

In an example embodiment, the shipment unit with advanced autonomous capabilities stores the shipment unit information/data thereon (e.g., in the computer storage) and only provides the computing node entity 100 and/or transaction computing entity 110 with the shipment unit information/data necessary to finalize full origin-to-destination route and/or only the next segment or leg of the route. In an example embodiment, the computing node entity 100 may store only basic information regarding the shipment unit 102 and/or associated shipment unit 104 having advanced autonomous capabilities. For example, the computing node entity 100 may store a shipment unit identifier and origin and destination for the shipment unit, and/or the like. In an example embodiment, a shipment unit with advanced autonomous capabilities may be fully autonomous and smart, allowing the shipment unit to autonomously negotiate rates and leverage different negotiation tactics encoded in the shipment unit-based and/or associated shipment unit-based computer storage and logic. In an example embodiment, if the shipment unit has advanced autonomous capabilities, the shipment unit 102 and/or associated shipment unit 104 may perform the step of matching the shipment unit information/data with one or more service offers, rather than the computing node entity 100.

In various embodiments, the computing node entity 100 and/or a shipment unit 102 and/or associated shipment unit 104 having advanced autonomous capabilities may include executable instructions, computer code/script, and/or the like that has the decision making logic for matching shipment unit information/data to one or more service offers is embedded within the computing node entity 100 and/or the shipment unit 102 and/or associated shipment unit 104 in the form of software, firmware, and/or hardware.

In an example embodiment, the decision making logic is configured to accept the first service offer and/or set of service offers (e.g., where each service offer covers a particular leg of transporting the shipment unit from the origin to the destination, and/or the like) that meets all the requirements of the shipment unit information/data. In an example embodiment, the decision making logic waits until a configurable number of service offers and/or sets of service offers meeting the requirements of the shipment unit information/data are identified and/or received and then selects the least expensive service offer and/or set of service offers. In another example embodiment, the decision making logic may select an optimal service offer and/or set of service offers from the configurable number of service offers and/or sets of service offers meeting the shipment unit information/data requirements based on a statistical model.

In an example embodiment, the decision making logic is configured to identify and/or receive a configurable number of service offers and/or sets of service offers that meet the requirements of the shipment unit information/data before making a decision, however, if the configurable number of service offers and/or sets of service offers are not identified and/or received within a configurable time period, the decision making logic may select the least expensive identified and/or received service offer and/or set of service offers.

In another example embodiment, if the configurable number of service offers are not identified and/or received within the configurable time period, the maximum cost for transporting the shipment unit may be increased by a configurable increment and/or another portion of the shipment unit information/data may be modified and service offers and/or sets of service offers meeting the requirements of the modified shipment unit information/data may then be identified and/or received.

In another example embodiment, if an acceptable service offer and/or set of service offers cannot be identified within a configurable time period, the shipment unit 102 and/or associated shipment unit 104 having advanced autonomous capabilities and/or a computing node entity 100 may communicate with a transaction computing entity 110 (e.g., operated by a customer, consignor, consignee) to request and/or receive further instructions.

It should be understood that in various embodiments, the decision making logic operating on the shipment unit 102 and/or associated shipment unit 104 having advanced autonomous capabilities and/or the computing node entity 100 may be programmed to select a service offer and/or set of service offers for transporting the shipment unit based on a variety of considerations.

In various embodiments, a shipment unit 102 and/or associated shipment unit 104 can include components, modules, or computer programs stored in memory to facilitate the negotiation of contracts autonomously. For example, if an exact match is not identified or determined based on initially-submitted shipment parameters, the shipment unit may alter certain parameters in an attempt to reach a deal. In some cases, the shipment unit 102 and/or associated shipment unit 104 may redefine the delivery service level classification (e.g., from overnight to 2nd day delivery by way of example only) and re-submit the delivery request to the service offer distributed ledger. In some instances, this new request for proposals may be communicated by the shipment unit to the corresponding blockchain, generally, or to a subset of initial respondents that were identified as being closest to the initial delivery parameters. The shipment unit may have multiple preprogramed fall back negotiation positions to propose based on the responses received. Of course, the altered parameters could be any shipment parameter or combination of parameters (e.g., target cost, mode, pickup date), among other things.

Continuing with FIG. 4, at block 406, the customer provides the physical shipment unit 102 and/or associated shipment unit 104 to logistics service provider. For example, a logistics service provider may pick up the shipment unit or a customer may bring the shipment unit to a facility operated by and/or on behalf of a logistics service provider. For example, the customer may physically tender the shipment unit 102 and/or associated shipment unit 104 to a logistics service provider/carrier/transporter. For example, the physical shipment unit 102 may enter the transportation network of a logistics service provider/carrier/transporter participating program that uses the service offer database (e.g., the stored service offers from one or more logistics service providers) to autonomously select a transportation plan for the shipment unit 102 and/or associated shipment unit 104. At block 408, the shipment unit information/data is accessed. For example, a barcode or other machine and/or human readable indicia on the shipment unit (e.g., written on the shipment unit and/or affixed to the shipment unit by a label/sticker) may be scanned, read, and/or the like to access at least a portion of the shipment unit information/data. For example, the machine and/or human readable indicia may comprise and/or encode the shipment unit identifier that may then be used access additional shipment unit information/data. In another example, an RFID tag on/in the shipment unit may be scanned, read, and/or the like to access at least a portion of the shipment unit information/data. For example, when the RFID tag is scanned, read, and/or the like, a transaction computing entity 110 may receive the shipment unit identifier and/or an encoded version thereof.

In an example embodiment, the RFID tag may provide shipment unit information/data in addition to the shipment unit identifier when scanned, read, and/or the like. In another example embodiment, the shipment unit 102 and/or associated shipment unit 104 may communicate with a transaction computing entity 110 directly and/or through one or more wired and/or wireless networks. For example, if the shipment unit has smart and/or advanced autonomous capabilities (e.g., is a smart shipment unit 102 and/or associated shipment unit 104 or an advanced autonomous shipment unit 102 and/or associated shipment unit 104), the shipment unit 102 located at the logistics service provider/carrier/transporter facility may communicate with a transaction computing entity 110 located at the logistics service provider/carrier/transporter facility using a Wi-Fi network local to the logistics service provider/carrier/transporter facility. Thus, the transaction computing entity 110 may receive the shipment unit identifier from the shipment unit via an optical scanner, an RFID receiver, communication interface, and/or the like. The shipment unit identifier and/or any other received shipment unit information/data may be provided to the computing node entity 100 by the transaction computing entity 110 (e.g., transmitted through one or more wired and/or wireless networks).

In an example embodiment, the shipment unit (e.g., a shipment unit 102 and/or associated shipment unit 104 having smart and/or advanced autonomous capabilities) may communicate with the computing node entity 100 instead of and/or in addition to communicating with the transaction computing entity 110. In another example, based on the shipment unit 102 and/or associated shipment unit 104 appearance, that is captured/provided by the customer computing entity 120 and/or provider computing entity 110 and relayed to the computing node entity 100, the shipment unit 102 and/or associated shipment unit 104 would be uniquely identified. The shipment unit information/data may then be retrievable from the shipment unit databases (which comprises a distributed ledger and/or blockchain data structure, in one embodiment) based on the appearance identification.

At block 410, relevant service offers are identified. For example, the computing node entity 100 may identify one or more relevant service offers. For example, a relevant service offer may be a service offer (e.g., stored in the service offer database) that shares an origin and/or destination location with the shipment unit information/data, shares an origin and/or destination with another relevant service offer, corresponds to an allowed transportation mode as indicated by the shipment unit information/data, does not pass through a geographical area to be avoided as indicated by the shipment unit information/data, allow for transportation of the shipment unit in accordance with the time and/or financial constraints, requirements, and/or preferences according to the shipment unit information/data, and/or the like. In an example embodiment, the relevant service offers may be filtered to only include service offers that would transport the shipment unit in accordance with global rules. For example, the global rules may address government regulations such as embargoes and sanctions as well as global denied party screening requirements. In an example embodiment, a global rule may be any filtering rule that is not based on the shipment unit information/data.

At block 412, the shipment unit information/data is matched to one or more service offers of the relevant service offers. For example, the computing node entity 100 (and/or the shipment unit 102 and/or associated shipment unit 104) may match the shipment unit information/data to one or more service offers. For example, a first relevant service offer may be to transport the shipment unit by cargo plane directly from the origin to the destination. The first relevant service offer may be in accordance with the time and financial requirements of the shipment unit information/data, but may not be in accordance with the temperature requirements of the shipment unit. Therefore, the shipment unit information/data is not matched to the first relevant service offer.

In another example, a second service offer may provide transportation from the origin to a first intermediate location, a third service offer may provide transportation from the first intermediate location to a second intermediate location, and a fourth service offer may provide transportation from the second intermediate location to the destination. The combination of the second, third, and fourth service offers may be in accordance with the time and financial requirements of the shipment unit information/data and each leg (corresponding to one of the second, third, or fourth service offer) may be in accordance with the temperature requirements of the shipment unit information/data.

In an example embodiment, a logistics service provider rating may also be used to select one or more service offers and/or to match one or more service offers to the shipment unit information/data. In an example embodiment, various weights may be applied to various aspects of the shipment unit information/data to identify a best service offer and/or set of service offers for transporting the shipment unit from the origin to the destination (e.g., the delivery address). For example, aspects of the shipment unit information/data that are required may be weighted more heavily that aspects of the shipment unit information/data that are preferences. As should be understood, the shipment unit information/data may be matched to one or more relevant service offers using various techniques.

At block 414, the transaction database is updated. For example, the computing node entity 100 may update the transaction database. In an example embodiment, the transaction database may comprise one or more blockchain structures. In an example embodiment, the computing node entity 100 may further communicate with one or more transaction computing entities corresponding to the one or more logistics service providers identified by the matched and/or selected service offer(s). For example, the selecting computing entity 100 may request that the one or more transaction computing entities schedule the transportation of the shipment unit by the corresponding logistics service provider/carrier/transporter in accordance with the selected service offer(s). For example, a record that identifies the shipment unit by the shipment unit identifier and identifies the selected service offer(s) (e.g., by the corresponding service offer identifier(s)) and/or other shipment unit information/data and/or service offer shipment unit information/data may be stored to the transaction database.

In an embodiment wherein the transaction database comprises one or more blockchain data structures and a transaction computing entity provides a node of the blockchain data structure, the communication of the new record to the transaction computing entity for inclusion in the blockchain structure stored thereby may act as a notification to the logistics service provider to schedule transportation of the shipment unit accordingly.

As should be understood, a first logistics service provider/carrier/transporter may transport the shipment unit along a first leg, a second logistics service provider/carrier/transporter may transport the shipment unit along a second leg, a third logistics service provider/carrier/transporter may transport the shipment unit along a third leg, and/or the like. Thus, various legs/segments of transporting the shipment unit from the origin to the destination may comprise the use of services provided by one logistics service provider or a plurality of logistics service providers. In an example embodiment, the transportation of the shipment unit may be transparent. For example, a customer (e.g., a consignee, a consignor) may be able to see which logistics service provider is transporting the shipment unit along each leg, for example, when accessing tracking information/data for the shipment unit. In another example, the transportation of the shipment unit may not be transparent. For example, when a customer (e.g., a consignee, a consignor) accesses tracking information/data for the shipment unit it may appear that the logistics service provider the shipment unit was tendered to is transporting the shipment unit from the origin to the destination, and/or the like.

At block 416, the shipment unit is transported through the transportation network(s) of one or more logistics service providers from the origin to the destination (e.g., delivery address). The shipment unit 102 and/or associated shipment unit 104 and/or one or more transaction computing entities 110 may provide information/data regarding the geolocation of the shipment unit periodically, regularly, upon the beginning and/or completion of a leg, when an environmental condition satisfies a threshold requirement (e.g., if the temperature drops below a predetermined temperature or raises above a predetermined temperature), and/or the like. Thus, the shipment unit 102 and/or associated shipment unit 104 and/or one or more transaction computing entities 110 may provide (e.g., transmit) transportation information/data to the computing node entity 100. The computing node entity 100 may then receive the transportation information/data. The transportation information/data may be stored by the computing node entity 100, for example, in a transportation database.

In an example embodiment, the transportation database comprises one or more blockchain data structures, distributed ledgers and/or databases, and/or the like. For example, the shipment unit 102 and/or associated shipment unit 104 may store and/or have access to a private key with writing permission for writing records corresponding to transportation information/data for the shipment unit (e.g., comprising the shipment unit identifier). Thus, transportation information/data (e.g., geolocation information/data for the shipment unit, environmental condition information/data corresponding to environmental conditions (e.g., temperature, vibrations, etc.) experienced by the shipment unit during transportation of the shipment unit from the origin to the destination) may be received by the computing node entity 100 and stored to the transportation database.

At block 418, after the completion of a leg, payment for the leg/segment may be facilitated. For example, the computing node entity 100 may receive information/data indicating that a particular leg/segment of transporting the shipment unit from the origin to the destination may be received. For example, a logistics service provider responsible for completing the leg/segment immediately after the particular leg/segment may indicate that they have received the shipment unit. In another example, a geolocation of the shipment unit may correspond to the completion of the particular leg, the next leg/segment beginning, and/or the like.

In an example embodiment, the indication of the completion of a particular leg/segment may comprise an indication of a transaction of control of the shipment unit and/or associated shipment unit comprising, for example, transaction information/data. For example, the indication of the completion of a particular leg/segment may comprise transaction information/data indicating and/or identifying a first, providing entity (e.g., logistics service provider/carrier/transporter, carrier personnel, carrier vehicle 107, carrier hub, and/or the like), a second, receiving entity(e.g., logistics service provider/carrier/transporter, carrier personnel, carrier vehicle 107, carrier hub, and/or the like), a geolocation where the transaction occurred, and/or the like. In an example embodiment, transaction information/data may be stored in the transportation database(s) and/or in a separate transaction database (e.g., a distributed ledger).

The computing node entity 100 may then facilitate the payment of the logistics service provider/carrier/transporter responsible for completing the particular leg/segment based on the deposit account information/data of the corresponding service offer information/data and the payment account information/data of the shipment unit information/data. In an example embodiment, the shipment unit 102 and/or associated shipment unit 104 may facilitate the payment for the completion of the particular leg. For example, the shipment unit 102 and/or associated shipment unit 104 may initiate the provision of funds to pay for the transportation of the shipment unit along the particular leg/segment from the payment account to an account associated with the computing node entity 100. The computing node entity 100 may then provide funds to pay for the transportation of the shipment unit along the particular leg/segment to the deposit account indicated in by the deposit account information/data of the corresponding service offer information/data.

In an example embodiment, payment for the transportation of the shipment unit along a particular leg/segment is not facilitated until the shipment unit reaches the destination and/or is delivered to the delivery address. In an example embodiment, information/data corresponding to the payment of service corresponding to the particular leg/segment may be stored in the transaction database.

As will be recognized, payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, Bluetooth low energy (BLE), and various other contactless payment systems. Further, such payment technologies may include PayPal Beacon, Booker, Erply, Leaf, Apple Pay, Leapset, Micros, PayPal Here, Revel, ShopKeep, TouchBistro, Vend, and/or the like. In an example embodiment the method(s) by which a customer is willing to provide payment may be included in the shipment unit information/data and the method(s) by which a logistics service provider is willing to accept payment may be included in the service offer information/data and these elements of the shipment unit information/data and the service offer shipment unit information/data may be taken into account in the matching step (e.g., described above with respect to block 412).

The service offer information/data may include information/data regarding how to provide the payment to the logistics service provider, in various embodiments. Similarly, in various embodiments, the shipment unit information/data may comprise information/data regarding how to extract payment from the customer for payment of transportation of the shipment unit. In an example embodiment, the payment for transportation of the shipment unit may be made directly from the customer (e.g., based on the payment account information/data) to the logistics service provider (based on the payment account information/data).

In an example embodiment, the computing node entity 100 may be configured to receive payment from the customer (e.g., based on the payment account information/data) in a receiving account associated with the computing node entity 100 and provide payment to the logistics service provider (based on the payment account information/data) from a payment account associated with the computing node entity 100. For example, in an example embodiment, a receiving account associated with the computing node entity 100 may act as an escrow account and receive funds for use for payment for the transportation of the shipment unit before the shipment unit is transported and/or before the completion of one or more legs. Payment for completion of one or more legs may be provided to the appropriate logistics service provider by the computing node entity 100 upon completion of the one or more legs. Any of the escrow funds not used to pay for transportation of the shipment unit may be returned to the customer (e.g., the customer's payment account) upon delivery of the shipment unit to the destination, for example.

Additionally, after completion of a particular leg, the computing node entity 100 and/or the shipment unit 102 and/or associated shipment unit 104 (in the case of an advanced autonomous shipment unit) may provide a rating for the logistics service provider responsible for transporting the shipment unit along the particular leg. For example, based on the transportation information/data, the computing node entity 100 and/or the shipment unit 102 and/or associated shipment unit 104 may determine if the shipment unit was transported along the leg/segment in accordance with the service offer and/or the shipment unit information/data and/or the degree to which the shipment unit was transported along the leg/segment in accordance with the service offer and/or the shipment unit information/data. For example, if, according to the transportation information/data, the shipment unit was transported along the leg/segment in the time frame indicated in the service offer, was transported along the route indicated in the service offer, in accordance with the environmental constraints, requirements, and/or preferences of the shipment unit information/data, in accordance with the cost indicated in the service offer, and/or the like, the logistics service provider may receive a very positive rating. If the shipment unit, according to the transportation information/data, was not transported in accordance with the service offer and/or with the shipment unit information/data (e.g., the special handling instructions were not carried out), the logistics service provider may receive a negative or less positive rating.

In an example embodiment, various aspects of the service offer information/data and/or associated shipment unit information/data may be weighted as to how much transporting the shipment unit not in accordance with that aspect will affect the rating of the logistics service provider. In an example embodiment, the degree to which the shipment unit was transported not in accordance with an aspect may be used to determine the rating. In another example, weather conditions and/or road conditions may be considered when determining the rating. For example, if a portion of the route the logistics service provider was to transport the shipment unit along was closed for police activity, an accident, weather conditions, and/or the like, the rating of the logistics service provider may not be or may be less negatively affected if the time frame in which the leg/segment is actually completed and/or the actual route taken differs from the time frame and/or route of the service offer. The computing node entity 100 and/or the shipment unit 102 and/or associated shipment unit 104 may write the logistics service provider rating to a rating database. In an example embodiment, the rating database may comprise one or more blockchain data structures. For example, the computing node entity 100 may write the determined rating and an updated logistics service provider rating to a record comprising the logistics service provider identifier to a blockchain data structure using a private key that is assigned writing privileges for the logistics service provider rating database.

In an example embodiment, the updated logistics service provider rating may be determined (e.g., by the computing node entity 100) based on the determined rating and the ratings for the logistics service provider in the logistics service provider rating database. In an example embodiment, the ratings determined more recently (e.g., within the last week, the last month, the last quarter, the last year, and/or the like) may be weighted more heavily than older ratings when determining the updated logistics service provider rating. In an example embodiment, the rating database may be managed, stored, and/or the like by and/or in association with a completed transaction system, module, database, blockchain data structure, and/or the like of the computing node entity 100.

At block 420, the shipment unit is delivered to the delivery address. For example, a logistics service provider corresponding with the service offer selected and/or matched to the information/data for the leg/segment that results in the delivering of the shipment unit to the delivery address may deliver the shipment unit to the delivery address. The shipment unit 102 and/or associated shipment unit 104 and/or a transaction computing entity 110 operated by and/or on behalf of the delivering logistics service provider may provide the computing node entity 100 with a delivery confirmation message, notification, alert, and/or the like. The platform entity 100 may, in response to receiving the delivery confirmation, ensure that the payment(s) due for transporting the shipment unit from the origin to the destination are resolved, that each logistics service provider involved in transporting the shipment unit from the origin to the destination has been rated, and/or the like. In an example embodiment, the computing node entity 100 (and/or shipment unit 102 and/or associated shipment unit 104 and/or transaction computing entity 110) may update the transportation database, transaction database, and/or the like to indicate the completion of the transporting of the shipment unit from the origin to the destination.

Example embodiments provide various technical advantages. For example, various embodiments allow for the automated matching of a shipment unit to the best service offers currently available for transporting the shipment unit from the origin to the destination. For example, various embodiments improve the functioning of a computer by providing a framework for the computing node entity 100 to be able to match shipment unit information/data to one or more service offers in an efficient and timely manner. Some example embodiments allow the shipment unit 102 and/or associated shipment unit 104 itself to select one or more service offers for transporting the shipment unit from the origin to the destination by leveraging various negotiation tactics encoded in the shipment unit-based and/or associated shipment unit-based computer storage and logic, thereby reducing the amount of computer operations performed by the computing node entity 100.

In an example embodiment, the shipment unit 102 and/or associated shipment unit 104 may store the shipment unit information/data such that the transaction computing entity 110 and/or the computing node entity 100 need to only store basic shipment unit information/data for the shipment unit, thereby reducing the amount of memory required for the transaction computing entity 110 and/or the computing node entity 100 to transport the shipment unit. In another example, based on the shipment unit 102 and/or associated shipment unit 104 appearance, that is captured/provided by the customer computing entity 120 and/or provider computing entity 110 and relayed to the computing node entity 100, the shipment unit 102 and/or associated shipment unit 104 is uniquely identified. Thus, in an example embodiment, no RFID, printed labels, smart labels barcodes, tags, character strings, Aztec Codes, MaxiCodes, Data Matrices, Quick Response (QR) Codes, matrix barcodes or two-dimensional barcodes, electronic representations, and/or the like, and/or the like is required to make initial identification and/or subsequent shipment unit 102 and/or associated shipment unit 104 identifications as the shipment unit is transported.

In another example embodiment, the shipment unit 102 and/or associated shipment unit 104 provides transportation information/data that is stored in an immutable ledger (e.g., a distributed ledger and/or blockchain data structure). Thus, the status of the shipment unit throughout the transporting of the shipment unit from the origin to the destination can be immutably tracked and unbiased, automated reviews and/or ratings of the logistics service providers may be determined. The logistics service provider ratings may then be applied to future matchings of shipment units and/or associated shipment units to service offers to help ensure the proper handling of the shipment unit. Thus, various embodiments provide a variety of improvements to computer-related technology, shipment unit routing technology, shipment unit tracking technology, and unbiased rating determination technology.

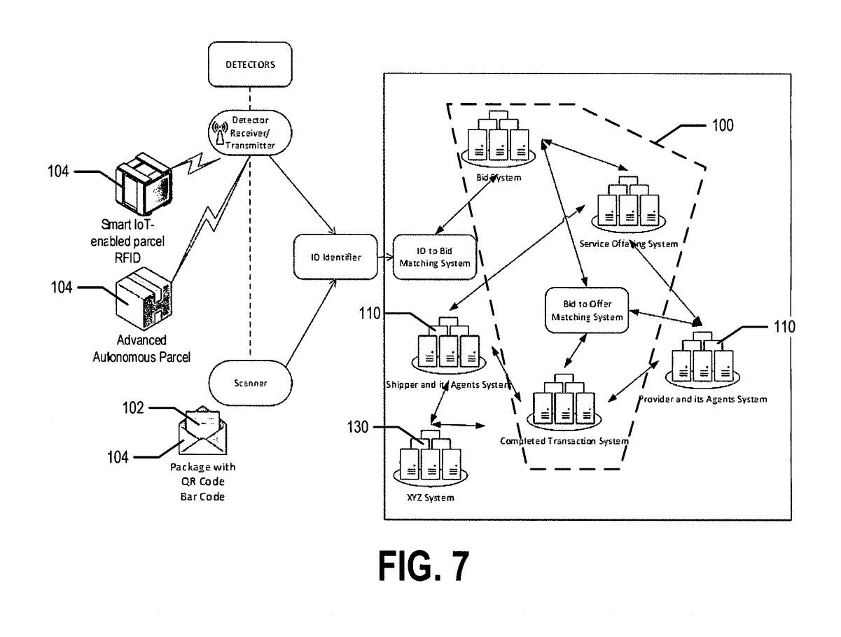

FIG. 7 provides a high level data flow diagram according to an example embodiment. For example, a transaction computing entity 110 may provide one or more service offers to a service offering system, module, database, blockchain data structure, and/or the like of the computing node entity 100, similar to as described above with respect to block 402. In another example, a shipper and/or an agent thereof may operate a customer computing entity 120 to provide shipment unit information/data (e.g., in the form of a transportation bid) to a bid system, module, database, blockchain data structure, and/or the like of the computing node entity 100, similar to as described above with respect to block 404. A shipment unit 102 and/or associated shipment unit 104 may provide a shipment unit identifier and/or other shipment unit information/data to the computing node entity 100 through an optical scanner, RFID receiver, Wi-Fi network, or other communication protocol and/or network, similar to as described above with respect to block 408.

An offer matching system, module, and/or the like of the computing node entity 100 and/or the shipment unit 102 and/or associated shipment unit 104 (e.g., for a shipment unit having advanced autonomous capabilities, and/or the like) may communicate with the service offer system, module, database, blockchain data structure, and/or the like; the bid system, module database, blockchain data structure, and/or the like; completed transaction system, module, database, blockchain data structure, and/or the like (e.g., for rating information/data); transaction computing entities 110; and/or the like to match a bid for transporting a shipment unit to one or more service offers, similar to as described above with respect to block 412. As the transportation of the shipment unit, and/or legs thereof, are completed, the completed transaction system, module, database, blockchain data structure, and/or the like may be updated to reflect transportation information/data, payment information/data corresponding to payment(s) for transporting the shipment unit, ratings for one or more logistics service providers corresponding to the transportation of the shipment unit, and/or the like. For example, the completed transaction system, module, database, blockchain data structure, and/or the like may provide information/data to the financial services computing entity 130 to facilitate payment of the transportation of the shipment unit and/or receive information/data indicating completion of a payment for the transportation of the shipment unit, similar to as described above with respect to blocks 414, 416, and 418. As should be understood, the computing node entity 100 may comprise various systems, modules, databases, blockchain data structures, and/or the like configured for autonomous matching of a bid for transporting a shipment unit (e.g., shipment unit information/data) to one or more services offers and for expediting the transportation of the shipment unit in accordance with the one or more selected service offers.

Various embodiments provide various technical improvements. In particular, various embodiments allow for the efficient automation of transportation plan determination for shipment units and/or associated shipment units. Moreover, various embodiments allow for the efficient automation of transportation plan determination for shipment units and/or associated shipment units that incorporate the transportation assets and/or resources of multiple logistics service providers/carriers/transporters. Various embodiments also provide for enhanced visibility of the shipment unit and/or associated shipment unit during transportation and improved monitoring of environmental conditions experienced by the shipment unit and/or associated shipment unit during transportation thereof.

### 2. Updating a Transportation Database

In various embodiments, one or more transportation databases may be maintained and/or updated to maintain chain-of-possession information regarding one or more shipment units and/or associated shipment units. In various embodiments, the one or more transportation databases may be one or more distributed ledger systems may be provided for maintaining chain-of-possession information regarding one or more shipment units (and/or one or more associated shipment units within said shipment units). As discussed herein, the distributed ledger system may be configured to store verified (e.g., multi-point verified) transaction information/data reflecting changes in possession of various shipment units and/or associated shipment units as the shipment units and/or associated shipment units are transported from an origin to a destination. The distributed ledger system may be carrier specific, such that the ledger reflects only changes of possession involving carrier personnel, or the distributed ledger system may be carrier-independent, such that change of possession information may be recorded regardless of the parties involved in the transaction.

Moreover, as discussed herein, the distributed ledger system may be configured to automatically transfer value (e.g., in the form of a digital currency existing within and/or associated with the distributed ledger system) upon the occurrence of various trigger events. These transfers of value may be performed in accordance with smart contracts (e.g., programmed scripts) stored within the distributed ledger (e.g., blockchain) system.

A. Recording Transactions to Reflect Changes-of-Possession of a Shipment Unit and/or Associated Shipment Unit

In various embodiments, the transaction database(s) may comprise one or more entity identifiers associated with a shipment unit. The entity identifier most recently associated with a shipment unit (e.g., shipment unit or shipment unit identifier) in the transaction database(s) may indicate the identity most recently in control of the shipment unit. In various embodiments, transactions may be recorded by changing an associated entity identifier corresponding to a particular token and/or shipment unit and/or associated shipment unit identification information/data in one or more transportation databases. As noted above, in one or more transportation databases (e.g., distributed ledger systems and/or blockchains), a plurality of “transaction/blocks” may be generated and utilized to store information/data corresponding to a particular shipment unit (and/or associated shipment unit) to be tracked by the system. In such embodiments, each block may comprise a control identifier indicating an entity, individual, and/or location in possession of the shipment unit and/or associated shipment unit. For example, each block may comprise at least a portion of shipment unit information/data corresponding to a particular shipment unit and/or associated shipment unit, and may comprise a control identifier indicative of an entity, individual, and/or location having possession of the shipment unit and/or associated shipment unit. Each individual transaction/block may be traceable to previously generated transactions/blocks, each of the previously generated transactions/blocks comprising corresponding control identifiers indicative of previous entities, individuals, and/or locations having possession of the shipment unit and/or associated shipment unit. Accordingly, a complete chain of control may be identified for each shipment unit and/or associated shipment unit by identifying transactions/blocks within the distributed ledger corresponding to the shipment unit and/or associated shipment unit. In an example embodiment, the transaction database(s) may be maintained, updated, and/or the like by a distributed ledger system comprising a plurality of computing node entities 100 in communication with one or more transaction computing entities 110, shipment units 102, shipment units 104, vehicles 107, and/or the like.

In certain embodiments, a new block may be generated and/or added to the blockchain each time control of a shipment unit and/or associated shipment unit changes. For example, each time a shipment unit and/or associated shipment unit is moved from one location to another, each time a shipment unit and/or associated shipment unit is handed off from one individual to another, and/or the like, a new block may be generated to identify the current control of the shipment unit and/or associated shipment unit. As discussed herein, each shipment unit 104 and/or associated shipment unit 102 may be wirelessly connected, and therefore control of the shipment unit and/or associated shipment unit may be self-monitored, by monitoring wireless connectivity between the shipment unit and/or associated shipment unit and one or more transaction computing entities 110 located proximate the shipment unit and/or associated shipment unit. As yet another example, one or more transaction computing entities 110 may be configured to monitor control of a shipment unit and/or associated shipment unit, and to provide updated control information/data to the computing node entities 100 to update the distributed ledger. For example, the transaction computing entities 110 may be configured to transmit wireless signals between various transaction computing entities 110 to signify a change in control of a shipment unit and/or associated shipment unit. The transaction computing entities 110 may be further configured to transmit information/data to various computing node entities 100 to record the change in control in the transportation database(s) (e.g., distributed ledger and/or blockchain system), by generating a new block to be stored in the distributed ledger and/or blockchain indicative of at least a portion of the shipment unit and/or associated shipment unit information/data as well as the control information/data.

a. Verifying Physical Transactions and Synchronizing Virtual Transactions with Verified Physical Transactions

In various embodiments, a plurality of transaction computing entities 110 may collectively verify digital and/or physical transactions involving one or more shipment units and/or associated shipment units. For example, at least two transaction computing entities 110 (e.g., handheld computing entities, IoT enabled shipment units 104 and/or associated shipment units 102, autonomous vehicles 107, vehicle computing entities, and/or the like) may be necessary to memorialize a transaction. A first transaction computing entity 110 associated with the first entity providing the shipment unit and/or associated shipment unit, and a second transaction computing entity 110 associated with the second entity receiving the shipment unit, may perform a virtual handshake and/or the like to signify the transaction of the shipment unit or shipment unit from the control of the first entity to the second entity. In an example embodiment, a computing node entity 100 may act as an intermediary in the virtual handshake. Thus, in certain embodiments, the computing node may utilize information/data received from a plurality of transaction computing entities 110 to verify the occurrence of a transaction. As one non-limiting example, the computing node may utilize transaction verification methodologies as discussed in co-pending U.S. patent application Ser. No. 14/942,034, the contents of which are incorporated herein by reference in their entirety.

To verify the occurrence of a transaction, the first transaction computing entity 110 may provide information/data to a computing node entity 100 indicating that a shipment unit and/or associated shipment unit is being transferred to a new control entity. In certain embodiments, the first transaction computing entity 110 may provide information/data indicating the identity of the receiving second transaction computing entity 110. Moreover, the second transaction computing entity 110 may also provide information/data to a computing node entity 100 indicating that the shipment unit and/or associated shipment unit is being transferred. The second transaction computing entity 110 may provide information/data indicating the identity of the providing first transaction computing entity 110, such that the providing and receiving transaction computing entities 110 may be verified based on the information received from both the first and second computing entities 110.

In certain embodiments, the shipment unit 104 and/or associated shipment unit 102 (e.g., a wirelessly connected shipment unit 104) may further provide information/data to the computing node entity 100 indicative of the transfer of control from a first transaction computing entity 110 to a second transaction computing entity 110. In such embodiments, the computing node entity 100 may verify the occurrence of a transaction transferring control of the shipment unit and/or associated shipment unit from the first transaction computing entity 110 to the second transaction computing entity 110 based on the information/data received from the first transaction computing entity 110, the second transaction computing entity 110, and/or the shipment unit 104, shipment unit label, shipment unit 102, shipment unit label or information/data provided by human operators of such computing entities (e.g., digital signatures, private/public key pairs, and/or the like).

Upon confirming the information/data received from each computing entity provides a consistent and/or identical record of the transaction, the computing node entity 100 may be configured to generate a new block to be stored in the distributed ledger indicative of the transaction. Upon determining that the information/data received from each of the computing entities is inconsistent (e.g., the identity of transaction computing entities 110 involved, the time of transaction occurrence, characteristics of the shipment unit and/or associated shipment unit during the transaction (e.g., package characteristics such as size, weight, condition, environmental consideration, material type, and/or the like), and/or the like), the computing node entity 100 may be configured to request additional verification information from each of the one or more computing entities (and/or additional computing entities) prior to storing information/data regarding the transaction in the distributed ledger. Accordingly, the distributed ledger may use verified transaction information/data when enforcing smart contracts as discussed herein.

Similarly, the computing node entities 100 may utilize verified shipment unit condition information/data received from the transaction computing entities and/or from the wirelessly connected shipment unit 102 and/or associated shipment unit 104 (e.g., based on sensors located within the shipment unit 102 and/or associated shipment unit 104) to verify the shipment unit condition prior to storing the same in the distributed ledger. Accordingly, the distributed ledger may utilize verified shipment unit condition information/data when enforcing smart contracts based on shipment unit condition.

b. Synchronizing Parallel (or Partially Parallel) Distributed Ledgers

As described above various shipment unit and/or associated shipment unit information/data may be stored in one or more transportation databases, distributed legers, and/or the like. In an example embodiment, the one or more transportation distributed ledgers may comprise two or more parallel or partially parallel distributed ledgers. For example, various embodiments encompass a plurality of parallel, or partially parallel distributed ledgers (e.g., blockchains) providing shipping/tracking information for shipment units, shipment unit labels, and/or the shipment units contained within those shipment units and/or a label on the shipment unit itself separately.

The plurality of distributed ledgers may be managed and/or at least partially synchronized by a distributed ledger management system. In certain embodiments, the distributed ledger management system may itself be distributed, and may comprise a plurality of computing node entities 100 (e.g., computing node entities 100 storing information/data stored in a plurality of distributed ledgers managed by the system). Accordingly, the distributed ledger management system may be configured to retrieve and/or share information/data between a plurality of distributed ledgers (e.g., blockchains). For example, to the extent that information/data stored in distributed ledgers is replicated between a plurality of distributed ledgers, the distributed ledger management system may be configured to automatically share information/data between the plurality of distributed ledgers.

In certain embodiments, a first distributed ledger (e.g., a shipment unit distributed ledger) provides shipping/tracking information/data (e.g., shipment unit information/data) relating to various shipment units and/or associated shipment unit labels, and a second distributed ledger (e.g., a shipment unit distributed ledger) provides shipping/tracking information (e.g., shipment unit information/data) relating to shipment units and/or associated shipment unit labels within those shipment units. Accordingly, a complete chain of control for the shipment units may encompass activities occurring before and/or after shipment of the shipment unit in a corresponding shipment unit.

Moreover, each distributed ledger may be configured for executing corresponding smart contracts relating to the shipment unit, shipment unit label, the shipment unit, or the shipment unit label, separately. For example, the shipment unit-based distributed ledger may be configured for monitoring shipment unit shipment parameters, and the shipment unit-based distributed ledger may be configured for monitoring shipment unit condition parameters.

In certain embodiments, the distributed ledger management system (e.g., one or more of the computing node entity 100 encompassing the distributed ledger management system) may be configured to automatically generate new transactions/blocks in each distributed ledger to reflect simultaneous movement of a shipment unit and a shipment unit contained within the shipment unit. In certain embodiments, upon receipt of information/data indicating a particular shipment unit is moving within a carrier network (e.g., a computer node entity 100 receiving information/data from one or more transaction computing entities 110 indicative of the movement of a shipment unit and/or associated shipment unit), the computing node entity 100 may be configured to update both the shipment unit distributed ledger and the shipment unit distributed ledger to reflect the change of control of the shipment unit and the shipment unit contained within the shipment unit.

In certain embodiments, the computing nodes 100 may be configured to simultaneously and/or periodically provide information/data specific to one of the plurality of distributed ledgers. For example, shipment unit condition information/data (e.g., shipment unit temperature, sensed shocks/impacts, and/or the like) may be provided and stored within the shipment unit distributed ledger, without providing the same information/data to the shipment unit distributed ledger.

In various scenarios, one or more shipment units may be added to and/or removed from a shipment unit during the transportation of the shipment unit and/or associated shipment units from their respective origins to their respective destinations. For example, for a product launch of a new smartphone, a large number of smartphones (e.g., shipment units) may be shipped within a shipment unit to a predetermined location near where the smartphones are to be delivered. At the predetermined location (and possibly at a predetermined date and/or time) the individual smartphones are removed from the shipment unit and delivered to their respective consignees. In such scenarios, it would be beneficial to be able to track each of the shipment units and the shipment unit as a whole.

In various embodiments, the maintaining of the parallel or partially parallel shipment unit distributed ledger and shipment unit distributed ledger allows for shipment units to be added to shipment units and/or associated shipment units to be removed from shipment units without having to replicate an entire blockchain and/or string of records. For example, the shipment unit distributed ledger and the shipment unit distributed ledger enable a pseudo blockchain/string of records split, but with reduced memory storage requirements. Thus, the parallel or partially parallel shipment unit distributed ledger and shipment unit distributed ledger reduce the amount of memory needed to provide granular data regarding each shipment unit and each shipment unit in situations where shipment units may be added to or removed from shipment units during the shipment of the shipment units and/or associated shipment units.

### B. Executing Smart Contracts

Smart contracts may be configured for execution based on various trigger events, information/data parameters, shipment unit or shipment unit conditions (e.g., as reflected by shipment unit and/or associated shipment unit information/data stored within the one or more distributed ledgers), and/or the like. In various embodiments, the smart contracts may be executed by a transfer of value (e.g., reflected in a separate distributed ledger corresponding to a virtual currency, such as Bitcoin, Ethereum, Litecoin, Ripple, Dogecoin, and/or the like), by initiating a particular action (e.g., executable entirely within the distributed ledger and/or at least partially executable outside of the distributed ledger, for example, by initiating a transfer of currency through traditional banking institutions), and/or the like. Examples of such smart contracts for transferring value are described below. It should be understood that such transfers of value are merely exemplary of various smart contracts that may be executed as a portion of a distributed ledger system as described herein, and these examples should not be construed as limiting.

As noted above, various embodiments may comprise ledger-specific smart contracts, such as shipment unit specific smart contracts and shipment unit specific smart contracts. As just one non-limiting example, the shipment unit specific smart contracts may be based on the completion of shipping services corresponding to a shipment unit in accordance with applicable shipping requirements, and the shipment unit-specific smart contracts may be based on the maintenance of applicable shipment unit conditions during the completion of the shipping services corresponding to a shipment unit contained within the shipment unit. For example, the shipment unit specific smart contracts may be configured to automatically transfer value (e.g., a digital currency) from the consignor to the carrier upon completion of shipping services to deliver the shipment unit within an applicable pick-up/transfer/delivery time-period and to an applicable pick-up/transfer/delivery destination. As another example, the shipment unit specific smart contracts may be configured to automatically transfer value (e.g., a digital currency) from the carrier to the consignor upon a determination that the shipment unit was not maintained within applicable shipment unit conditions (e.g., temperature conditions, drop limitations, and/or the like).

a. Transferring Value upon Completion of a Shipment Unit and/or Associated Shipment Unit Transport

In various embodiments, value may be transferred to the carrier to complete shipping services. In certain embodiments, value may be transferred to the carrier prior to completing the shipping services, however in certain embodiments, value may be transferred to the carrier only upon successfully completing the shipping services. In the former embodiments, value may be transferred to the carrier prior to completing the shipping services, however value may be transferred back to the consignor (and/or another party) upon determining that the shipping services were not completed according to prescribed parameters. For example, upon determining that the shipment unit was delivered late, delivered to the wrong location, was not maintained at an appropriate temperature or within an allowed temperature range during the entirety of the transportation of the shipment unit, and/or the like, the distributed ledger may be configured to automatically transfer at least a portion of the value of the shipping services back to the consignor and/or consignee (e.g., to an account corresponding to the consignor and/or consignee).

In other embodiments, the distributed ledger may be configured to automatically transfer value from the consignor (and/or consignee) to the carrier upon completion of the shipping services. The amount of value transferred to the carrier may be based on a determination of whether the shipping services were completed according to prescribed parameters. Upon determining that the shipping services were completed according to prescribed parameters, an agreed-upon full value of the shipping services may be transferred to the carrier. However, upon determining that the shipping services were not completed according to prescribed parameters, only a portion of the agreed value may be transferred to the carrier.

In certain embodiments, completion of shipping services may be ascertained based at least in part on verified information/data provided to and stored within the transportation database(s) (e.g., distributed ledger(s), blockchain(s), and/or the like) from one or more transaction computing entities 110. In certain embodiments, the information/data provided to the transportation database(s) (e.g., distributed ledger(s), blockchain(s), and/or the like) may be indicative of the shipment unit and/or associated shipment unit being located at a predefined location (e.g., a destination location), a particular leg of the transportation of the shipment unit and/or associated shipment unit from the origin to the destination being completed (e.g., as indicated by transaction indicating transfer of control from a first entity to a second entity).

For example, upon the shipment unit and/or associated shipment unit arriving at a destination location corresponding to the shipment unit, one or more transaction computing entities 110 (e.g., the shipment unit 104, shipment unit 102, vehicle 107, one or more handheld devices, and/or the like) may be configured to verify the location of the shipment unit and/or associated shipment unit, and may provide information/data to one or more computing node entities 100 associated with the distributed ledger constituting at least a portion of the transportation database indicative of the location of the shipment unit and/or associated shipment unit being at the corresponding destination location. Upon determining the location of the shipment unit and/or associated shipment unit (e.g., by the computing node entity 100 based on information/data received from a transaction computing entity 110, vehicle 107, shipment unit 104, and/or associated shipment unit 102) is a predefined corresponding location, one or more applicable smart contracts may be configured to transfer value to the carrier.

In certain embodiments, determining the completion of shipping services may be ascertained based at least in part on information/data indicating a particular task and/or transaction has occurred. For example, one or more transaction computing entities may be configured to verify a delivery task has been completed for a particular shipment unit. The one or more transaction computing entities may provide information/data to the distributed ledger indicating that the delivery task has been completed, and may execute a smart contract to transfer value to the carrier for the completion of the delivery task.

It should be understood that any of a variety of trigger events (e.g., verified information/data indicative of the occurrence of a trigger event) may be utilized to execute one or more smart contracts. In various embodiments, a computing node entity 100 may identify a trigger event and execute and/or cause execution of the corresponding smart contract or portion thereof. For example, various smart contracts may be executed upon a shipment unit and/or associated shipment unit being picked up and/or the possession of the shipment unit being transferred between parties (e.g., between multiple carriers).

b. Transferring Value based on Shipment Unit and/or Associated Shipment Unit Condition

Moreover, as discussed herein, the distributed ledger system may be configured to transfer value based on an agreed upon value of the shipment unit transported within the shipment unit in accordance with one or more predefined conditions. In certain embodiments, the distributed ledger system may monitor the condition of the shipment unit 102 during transit (e.g., based on information/data received from the sensors within the shipment unit 104 and/or secured to the shipment unit 102), and may automatically determine whether value should be transferred based on the condition of the shipment unit.

For example, upon determining that the shipment unit was exposed to temperatures outside of a prescribed range, the shipment unit was dropped, the shipment unit was crushed, and/or otherwise damaged, the distributed ledger system (e.g., one or more computing node entities 100) may automatically transfer and/or cause transfer of value from the carrier to the consignor and/or consignee. Moreover, upon determining that the shipment unit was destroyed, the distributed ledger system may automatically transfer the entire value of the shipment unit from the carrier to the consignor and/or consignee. As should be understood, the value may be transferred in any currency agreed upon by the parties of the transaction (e.g., the consignor and/or consignee and the carrier).

### V. Conclusion

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for monitoring the transportation of a shipment unit from an origin to a destination, the method comprising:
storing in a service offer distributed ledger, by a computing node entity comprising at least one processor, a memory, and a communications interface configured to communicate via at least one network, one or more received service offers for transporting the shipment unit through at least a portion of a transportation network, wherein each of the one or more received service offers is associated with an entity account;
storing in a transportation distributed ledger, by the computing node entity, received shipment unit data that corresponds to the shipment unit, the corresponding shipment unit data comprising (a) an origin, (b) a destination, and (c) one or more transportation parameters;
generating at least a portion of a transportation plan for the shipment unit in response to a determined match between a first service offer of the one or more stored service offers and the stored shipment unit data, the transportation plan having one or more portions that collectively define a movement of the shipment unit from the origin to the destination in accordance with the one or more transportation parameters;
storing in the transportation distributed ledger, by the computing node entity, a received indication that at least the portion of the transportation plan was completed in accordance with the first service offer; and
causing payment, by the computing node entity, to the entity account associated with the first service offer based on the received indication.

2. The method of claim 1, wherein the match is determined by the shipment unit.

3. The method of claim 1, further comprising storing in the transportation distributed ledger, by the node computing entity, at least one of (a) geolocation data corresponding to the shipment unit or (b) environmental condition data corresponding to the shipment unit.

4. The method of claim 1, wherein the transportation distributed ledger comprises a first shipment unit database to store shipment unit data, and a second shipment unit database to store associated shipment unit data, the first shipment unit database and the second shipment unit database being partially parallel distributed ledgers.

5. The method of claim 4, wherein at least one of the shipment unit data or the associated shipment unit data comprises at least one of (a) a location or (b) a time when the associated shipment unit is to be either removed from or added to the shipment unit.

6. The method of claim 1, wherein the payment is caused by an automated execution of one or more smart contracts stored on at least one of the service offer distributed ledger and the transportation distributed ledger.

7. The method of claim 1, further comprising:
receiving environmental data corresponding to one or more environmental conditions of the shipment unit; and
determining a value for the payment based on the received environmental data, the first service offer, and the stored shipment unit data.

8. The method of claim 1, further comprising:
storing, to the service offer distributed ledger, a rating for the entity account associated with the first service offer, wherein the rating is determined based at least in part on the received environmental data, the first service offer, and the stored shipment unit data.

9. An apparatus for monitoring the transportation of a shipment unit containing at least an associated shipment unit from an origin to a destination, the apparatus comprising at least one processor, a communications interface configured for communicating via at least one network, and at least one memory storing computer program code, wherein the at least one memory and the computer program code is configured to, with the at least one processor, cause the apparatus to:
store in a service offer distributed ledger one or more service offers to transport a shipment unit through at least a portion of a transportation network, wherein each of the one or more service offers is received via the network from a corresponding service entity account;
store in a transportation distributed ledger received shipment unit data that corresponds to the shipment unit, the received shipment data comprising (a) an origin, (b) a destination, and (c) one or more transportation parameters;
match at least a first service offer stored in the service offer distributed ledger with the shipment unit data stored in the transportation distributed ledger to generate, in accordance with the stored one or more transportation parameters, at least a portion of a transportation plan for the shipment unit, wherein at least the portion of the transportation plan is generated in response to the match;
store in the transportation distributed ledger a received indication that the at least the portion of the transportation plan is completed; and
causing payment to the entity account that corresponds to the matched first service offer based on the received indication.

10. The apparatus of claim 9, wherein the at least one memory and the computer program code are further configured to, with the processor, cause the apparatus to store in the transportation distributed ledger information at least one of (a) geolocation data received from the first shipment unit or (b) environmental condition data received from the shipment unit.

11. The apparatus of claim 10, wherein the geolocation data and the environmental condition data is determined by one or more sensors disposed on or within the shipment unit.

12. The apparatus of claim 9, wherein the transportation distributed ledger comprises a first shipment unit database for storing shipment unit data and a second shipment unit database for storing associated shipment unit data, the first shipment unit database and the second shipment unit database being partially parallel distributed ledgers.

13. The apparatus of claim 12, wherein at least one of the shipment unit data or the associated shipment unit data comprises at least one of (a) a location or (b) a time when the associated shipment unit is to be removed from or added to the shipment unit.

14. The apparatus of claim 9, wherein the at least one memory and the computer program code are further configured to, with the processor, cause the apparatus to at least:
store, to the service offer distributed ledger, a rating determined for the entity account associated with the first service offer, wherein the rating is determined based at least in part on the received environmental data, the first service offer, and the stored shipment unit data.

15. The apparatus of claim 9, wherein the at least one memory and the computer program code are further configured to, with the processor, cause the apparatus to at least:
receive environmental data corresponding to one or more environmental conditions detected by one or more sensors associated with the shipment unit; and
determine a value for the payment based on the received environmental data, the first service offer, and the stored shipment unit data.

16. A computer program product for monitoring the transportation of a shipment unit containing at least one associated shipment unit from an origin to a destination, the computer program product comprising at least one non-transitory computer-readable storage medium having computer-executable program code instructions stored therein, the computer-executable program code instructions comprising program code instructions configured to, when executed by a processor of a node computing entity cause the node computing entity to:
store in a service offer distributed ledger one or more service offers to transport the shipment unit through at least a portion of a transportation network, wherein each service offer of the one or more service offers is received from a corresponding service account;
store in a transportation distributed ledger received shipment unit data that corresponds to the shipment unit, the received shipment unit data comprising (a) an origin, (b) a destination, and (c) one or more corresponding transportation parameters;
match at least a first service offer of the one or more service offers stored in the service offer distributed ledger with the shipment unit data stored in the service offer distributed ledger to trigger a generation of at least a corresponding portion of a transportation plan for the first shipment unit;
store in the transportation distributed ledger a received indication that the corresponding portion of the transportation plan is completed in accordance with the first service offer; and
cause payment to the service account corresponding to the first service offer based at least in part on the received indication.

17. The computer program product of claim 16, wherein the at least one memory and the computer program code are further configured to, with the processor, cause the apparatus to at least store in the transportation distributed ledger received information that corresponds to at least one of (a) a geolocation of the shipment unit or (b) an environmental condition of the shipment unit.

18. The computer program product of claim 17, wherein (a) the geolocation of the shipment unit or (b) the environmental condition of the shipment unit is determined by one or more sensors disposed on or within the shipment unit.

19. The computer program product of claim 16, wherein the payment is caused by an automated execution of one or more smart contracts stored on at least one of the service offer distributed ledger and the transportation distributed ledger.

20. The computer program product of claim 16, wherein the at least one memory and the computer program code are further configured to, with the processor, cause the apparatus to at least:
receive environmental data corresponding to one or more environmental conditions of the shipment unit; and
determine a value for the payment based at least in part on the received environmental data.
